(19) United States
(12) Patent Application Publication
(10) Pub. No.: US 2026/0130828 A1
(43) Pub. Date: May 14, 2026

(54) AUTOMATED DISPENSING UNITS FOR DRUG PARTICLES, DISPENSING STATIONS AND SYTEMS COMPRISING THE SAME, AND METHODS OF AUTOMATEDLY DISPENSING DRUG PARTICLES

(71) Applicant: Hong Kong Centre for Logistics Robotics Limited, Hong Kong (CN)

(72) Inventors: Yunhui LIU, Hong Kong (CN); Dong WANG, Hong Kong (CN); Kang SHAO, Hong Kong (CN)

(21) Appl. No.: 18/944,003

(22) Filed: Nov. 12, 2024

(51) Int. Cl. A61J 7/00; A61J 1/14; G05B 15/02

(52) U.S. Cl. CPC A61J 7/0076; A61J 1/14; G05B 15/02; A61J 2205/00; A61J 2205/30

(57) ABSTRACT

In some embodiments, provided is automated dispensing units, stations, systems and methods for drug particles. The dispensing unit comprises: a bowl feeder, a feeder track, a discharge mechanism and a blanking track, wherein, when in operation, the bowl feeder is configured to rotationally vibrate such that the drug particles disposed in the bowl are moved upward towards the bowl discharge port along the spiral bowl feeder track. Other example embodiments are described herein. In certain embodiments, provided dispensing units, stations, systems and methods achieve full automation from receiving prescription information to drug sorting, dispensing and packaging, resulting in fast sorting speed and high sorting accuracy.

### FIELD OF INVENTION

This application relates to devices, systems and methods for automated dispensing drug particles. In particular, this application relates to automated dispensing units for drug particles, dispensing stations and systems comprising the same, and methods of automatedly dispensing drug particles.

### BACKGROUND OF INVENTION

Medicines to be taken by patients such as the elderly in the nursing home are usually completed by manual dispensing by the staff. Because the number of the prescriptions to be handled is large, and the type and quantity of the medicines taken by each patient are not the same, this will cause low efficiency and low accuracy and precision in drug dispensing.

In addition, as people age, the eyesight and energy levels of elderly patients decrease, which reduces their ability to manage medications accurately and effectively. When faced with their own prescriptions and multiple types of drugs, the complexity of prescription information and drug information will bring challenges to the elderly in sorting the medications by themselves, thereby increasing the probability of sorting errors. In addition, the elderly with poor eyesight or serious conditions will even be unable to sort their medications, and this situation will bring great trouble to elderly patients. With the emergence of an ageing society, this problem needs to be given sufficient attention and effective solutions need to be found to solve the problems.

Certain available dispensers, systems and methods are attempting to address some of the problems. However, they are not fully automated, expensive, complex, with limited adaptability to various drug characteristics (e.g., special shapes), easy crushing of drug particles, difficult in balancing speed and accuracy, having cleaning and flexibility issues, and/or unable to handle single drug particles with packaging.

Accordingly, there is an urgent need for new solutions to address at least one or more of the above issues.

### SUMMARY OF INVENTION

Disclosed herein are novel automated dispensing units for drug particles, dispensing stations comprising the same, systems comprising the dispensing stations, and methods of automatedly dispensing drug particles, which are useful for dispensing drug particles with high speed and accuracy, high adaptability to drugs with special shapes or formats, and/or being able to handle different shapes and sizes of drugs, fragility and powder problems of bare drugs, and limitations on the number of drugs to be dispensed by a single device. In certain embodiments, the present invention provides systems, methods, and devices for automatic dispensing of drug particles such as solid drugs, including naked drugs and individually packaged drugs.

In certain embodiments, the system contains a dispensing system, a visual inspection system, and a packaging system, ultimately enabling the construction of a complete automated production line for drug dispensing, inspection, and packaging.

In some embodiments, provided is an automated dispensing unit for drug particles, including a bowl feeder, including a bowl including a bowl base; a bowl discharge port; and a spiral bowl feeder track configured to connect between the bowl base and the bowl discharge port; a feeder track, including a feeder track inlet; and a feeder track outlet; a discharge mechanism, including a driving cylinder; and a pick; a blanking track, including a blanking track inlet; and a blanking track outlet, wherein, when in operation, the bowl feeder is configured to vibrate such that the drug particles disposed in the bowl are moved upward towards the bowl discharge port along the spiral bowl feeder track, wherein the bowl discharge port is configured to operatively connect with the feeder track inlet, and the feeder track outlet is configured to operatively connect with the discharge mechanism, such that the drug particles from the bowl feeder are received and delivered to the discharge mechanism along the feeder track, and wherein the driving cylinder is configured to drive the pick to be movable between a first position that is juxtapose with the feeder track outlet and a second position that is juxtapose with the blanking track inlet, such that at least one drug particles are dispensed into the blanking track by the pick when the pick is moved from the first position to the second position.

In some embodiments, provided is an automated dispensing station for drug particles, comprising one or more drug dispensing units.

In some embodiments, provided is a system for automated dispensing of drug particles, comprising a plurality of dispensing stations; a plurality of medicine boxes, configured to receive drug particles dispensed from at least one dispensing station ; a transportation mechanism, operatively connected with the plurality of dispensing stations and configured to transport one or more of the medicine boxes to at least one of the plurality of dispensing stations to form a production line ; and a central control unit, configured to control operation of the system, wherein one or more designated medicine boxes are transported along the production line, and one or more designated drug particles are dispensed from one or more designated dispensing stations and collected in the one or more designated medicine boxes, in response to one or more input instructions.

In some embodiments, provided is a method of automatedly dispensing drug particles, comprising the steps of: providing a system; processing a prescription information to form an input instruction, and binding the input instruction to a designated medicine box; transporting the designated medicine box along the production line to one or more designated dispensing stations; and dispensing the designated drug particles from the one or more designated dispensing stations to the designated medicine box in response to the input instruction, until all drug particles in need are collected in the designated medicine box.

There are many advantages of the invention. In certain embodiments, provided dispensing units, stations, systems and methods solve the existing problem of manual sorting or dispensing of prescription drugs, and achieve automatic drug sorting, dispensing and packaging. In certain embodiments, provided dispensing units, stations, systems and methods realize prescription information processing, automatic sorting, automatic dispensing, automatic packaging, automatic detection, automatic replenishment of drug particles. In certain embodiments, provided dispensing units, stations, systems and methods realize full automation in the process from receiving prescription information to drug sorting, dispensing and packaging, and achieve the purpose of fast sorting speed and high sorting accuracy. In certain embodiments, provided dispensing units, stations, systems and methods enabled automatic dispensing of solid drugs or packaged drugs. By combining a visual inspection system and a packaging system, an automated production line is formed to handle the entire process from dispensing, detection to packaging. In certain embodiments, packaged drug particles according to each dose can be prepared based on prescription information. In certain embodiments, each package contains the dosage that the patient needs to take at a time, and the patient only needs to tear open the package for each dose, saving the trouble of dispensing drug particles themselves and avoiding the adverse consequences caused by taking the wrong dosage of drug particles.

In certain embodiments, the provided dispensing units contain a vibratory bowl feeder, a direct feeder, and a counting mechanism, which can greatly improve dispensing efficiency compared to existing dispensing equipment. In certain embodiments, the provided dispensing units solve the problems of the current dispensing equipment which mainly uses rotating mechanism screening methods, such as easy crushing of drugs, easy generation of powder from naked drugs, and difficult self-cleaning powder accumulation. In certain embodiments, the provided dispensing units dispense single drug particles or granules with packaging that cannot be dispensed by existing equipment. In certain embodiments, the provided dispensing units have a structure that is simple and easy to clean. In certain embodiments, the provided dispensing units have a structure that is reliable, robust and not easy to damage. In certain embodiments, the provided dispensing units can handle medicines of different sizes, shapes and forms and thus the dispensing units have strong versatility.

In certain embodiments, the provided dispensing units and dispensing stations are in modular design which can be combined or incorporated into a production line, combined with visual detection modules and packaging modules, to complete the dispensing and packaging of substantially all (e.g., around 99%) of solid drugs or packaged drugs on the market, which cannot be achieved by existing equipment.

In certain embodiments, the provided dispensing units have a novel vibratory bowl feeder and packaging machine that has targeted improvements based on existing universal products. In certain embodiments, the provided dispensing units can be used for specialized drug dispensing and packaging and can be combined in a modular manner for use in production lines. In certain embodiments, the provided dispensing systems provided an automatic drug dispensing production line that can handle and dispense multiple drug particles or pills and packaged in individual dosage form according to a prescription.

In certain embodiments, the provided dispensing station contains multiple dispensing units operatively connected together, which can realize dispensing of multiple different drug particles in one dispensing station. In certain embodiments, the provided dispensing station can realize the functions of automatic replenishment of drug particles and automatic cleaning. In certain embodiments, the provided dispensing system contains multiple dispensing stations operatively connected together in a production line and achieve fast and accurate dispensing purposes.

In certain embodiments, the provided dispensing system contains a packaging module used to package solid drug granules and realize automatic receiving of medicine boxes, automatic printing labels and automatic packaging of dispensed drug particles. In certain embodiments, the provided dispensing stations are modular and can be easily adopted in the pharmaceutical dispensing production line.

In certain embodiments, the provided dispensing system contains medicine box that can move on the production line (or assembly line), and the medicine box can be used to hold the solid drug particles or medicines needed by the patient separately in various compartments. In certain embodiments, the provided medicine box can be automatically opened and closed according to the needs to realize automatic filling and dropping of medicines. In certain embodiments, the provided medicine box is equipped with a unique identifier such as a bar code and RFID tag, which can be read by reader in the production line of the system.

### BRIEF DESCRIPTION OF FIGURES

FIG. 1A is a perspective view of an example automated dispensing unit for drug

particles, according to an example embodiment.

FIG. 1B is a perspective view of the example automated dispensing unit, with the outer shell removed, according to the example embodiment of FIG. 1A.

FIG. 1C is another perspective view of the example automated dispensing unit, showing charging situation of storage bin, according to the example embodiment of FIG. 1B.

FIG. 2A is a perspective view of an example dispensing unit, with the shell, the top supporting plate, and the storage bin removed, according to an example embodiment.

FIG. 2B is another perspective view of the example dispensing unit, according to the example embodiment of FIG. 2A.

FIG. 2C is a close-up view of the example dispensing unit, according to the example embodiment of FIG. 2A.

FIG. 2D is another close-up view of the example dispensing unit, showing discharging of drug particles through a discharge mechanism, according to the example embodiment of FIG. 2A.

FIG. 2E is another close-up view of the example dispensing unit, showing the location of a sensor at discharge mechanism, according to the example embodiment of FIG. 2A.

FIG. 2F is another close-up view of the example dispensing unit, showing the location of the sensors at blanking track, according to the example embodiment of FIG. 2A.

FIG. 3A is a perspective view of an example dispensing station, according to an example embodiment.

FIG. 3B is another perspective view of the example dispensing station, with double doors on the four sides of each layer removed, according to the example embodiment of FIG. 3A.

FIG. 3C is another perspective view of the example dispensing station, with double doors on the four sides of each layer and the shells of the dispensing units removed, according to the example embodiment of FIG. 3A.

FIG. 3D is a front view of the example dispensing station, with double doors on the four sides of each layer and the shells of the dispensing units removed, according to the example embodiment of FIG. 3A.

FIG. 3E is another perspective view of the example dispensing station, with double doors on the four sides of each layer and the dispensing units removed, showing the dispensing pipes, according to the example embodiment of FIG. 3A.

FIG. 4 is a schematic diagram of an overall layout of an example schematic dispensing system, according to an example embodiment.

FIG. 5A is a top perspective view of an example dispensing system, according to an example embodiment.

FIG. 5B is a schematic diagram of an example dispensing system, showing movement routes of medicine boxes on the production line, according to the example embodiment of FIG. 5A.

FIG. 6A is a top perspective view of an example medicine box, according to an example embodiment.

FIG. 6B is bottom perspective view of an example medicine box, according to the example embodiment of FIG. 6A.

FIG. 6C is another perspective view of an example medicine box, showing parts of driving mechanisms, according to the example embodiment of FIG. 6A.

FIG. 6D is a side view of an example medicine box, showing parts of driving mechanisms, according to the example embodiment of FIG. 6A.

FIG. 6E is a perspective view of an upper cover of an example medicine box, according to the example embodiment of FIG. 6A.

FIG. 6F is a perspective view of a lower cover of an example medicine box, according to the example embodiment of FIG. 6A.

FIG. 6G is a perspective view of a middle body of an example medicine box, according to the example embodiment of FIG. 6A.

FIG. 6H is a top perspective view of an example medicine box with its upper cover in an open position, according to the example embodiment of FIG. 6A.

FIG. 6I is a top view of an example medicine box with its upper cover in an open position, according to the example embodiment of FIG. 6A.

FIG. 6J is a bottom perspective view of an example medicine box with its lower cover in an open position, according to the example embodiment of FIG. 6A.

FIG. 6K is a bottom view of an example medicine box with its lower cover in an open position, according to the example embodiment of FIG. 6A.

FIG. 7 is a schematic workflow diagram of an example method of automatedly dispensing drug particles, according to an example embodiment.

FIG. 8 is a schematic workflow diagram of an example drug dispensing and packaging process, according to an example embodiment.

FIG. 9 is a schematic workflow diagram of automatic dispensing and discharging process using an example dispensing station, according to an example embodiment.

FIG. 10 is a schematic workflow diagram of an example medicine box exercise, according to an example embodiment.

FIG. 11 is a schematic workflow diagram of an automatic replenishment process of an example dispensing station, according to an example embodiment.

### DETAILED DESCRIPTION

### Definitions

As used herein and in the claims, the terms “comprising” (or any related form such as “comprise” and “comprises”), “including” (or any related forms such as “include” or “includes”), “containing” (or any related forms such as “contain” or “contains”), means including the following elements but not excluding others. It shall be understood that for every embodiment in which the term “comprising” (or any related form such as “comprise” and “comprises”), “including” (or any related forms such as “include” or “includes”), or “containing” (or any related forms such as “contain” or “contains”) is used, this disclosure/application also includes alternate embodiments where the term “comprising”, “including,” or “containing,” is replaced with “consisting essentially of” or “consisting of”. These alternate embodiments that use “consisting of” or “consisting essentially of” are understood to be narrower embodiments of the “comprising”, “including,” or “containing,” embodiments.

For the sake of clarity, “comprising”, including, and “containing”, and any related forms are open-ended terms which allows for additional elements or features beyond the named essential elements, whereas “consisting of” is a closed end term that is limited to the elements recited in the claim and excludes any element, step, or ingredient not specified in the claim.

As used herein, the singular forms “a”, “an” and “the” are intended to include the plural forms as well, unless the context clearly indicates otherwise. Where a range is referred in the specification, the range is understood to include each discrete point within the range. For example, 1-7 means 1, 2, 3, 4, 5, 6, and 7.

As used herein, the term “about” is understood as within a range of normal tolerance in the art and not more than ±10% of a stated value. By way of example only, about 50 means from 45 to 55 including all values in between. As used herein, the phrase “about” a specific value also includes the specific value, for example, about 50 includes 50.

As used herein and in the claims, the terms “general” or “generally”, or “substantial” or “substantially” mean that the recited characteristic, angle, shape, state, structure, or value need not be achieved exactly, but that deviations or variations, including for example, tolerances, measurement error, measurement accuracy limitations and other factors known to those of skill in the art, may occur in amounts that do not preclude the effect the characteristic was intended to provide. For example, an object that has a “generally” cylindrical shape would mean that the object has either an exact cylindrical shape or a nearly exact cylindrical shape. In another example, an object that is “substantially” perpendicular to a surface would mean that the object is either exactly perpendicular to the surface or nearly exactly perpendicular to the surface, e.g., has a 5% deviation.

It is to be understood that terms such as “top”, “bottom”, “iddle”, “side”, “bottom”, “length”, “inner”, “outer”, “interior”, “exterior”, “outside”, “vertical”, “horizontal” and the like as may be used herein, merely describe points of reference and do not limit the present invention to any particular orientation or configuration.

Further, terms such as “first”, “second”, “third”, etc., merely identify one of a number of portions, components and/or points of reference as disclosed herein, and likewise do not limit the present invention to any particular configuration or orientation.

As used herein, “connecting”, “connect”, “connected” means directly or indirectly bound to other elements. In some examples, these terms means (directly or indirectly) physically bound to other elements.

As used herein and in the claims, the term “operatively connects” or “operatively connected” refers to a functional or operational connection between two components or systems that allows them to work together or interact with each other. Such connection may be direct or indirect, and may be physically, functionally and/or electronically connected.

As used herein, the term “movable” will refer to having the ability to move, for example, having the ability to change position.

As used herein, the terms “automated dispensing unit”, or “dispensing unit” are used interchangeably and refer to a device or system which can dispense drug particles without substantive human intervention.

As used herein, the terms “automated dispensing station”, or “dispensing station” are used interchangeably and refer to a device or system which contains and/or operatively connects with one or more dispensing units.

As used herein, the terms “automated dispensing system”, “dispensing system”, or “system” are used interchangeably and refer to a system which contains and/or operatively connects with one or more dispensing stations. In some examples, the dispensing system also contains medicine box, transportation mechanism and/or central control unit.

As used herein, the terms “controller”, “control unit” or “controlling system” are used interchangeably and refer to are used interchangeably and refer to a device or system which manages or controls the operation of one or more components of the dispensing unit, dispensing station and/or dispensing system.

As used herein, the terms “drug particle”, “medicine”, or “drug” are used interchangeably and refer to individual solid or semi-solid dosage form of medication such as but not limited to granule, pellet, tablet, capsule, lozenge, sachet, medicine, with or without packaging. In some examples, drug particles also include powder, semi-liquid, liquid, or gaseous form in solid packaging (such as blister, ampoule, vial, capsule, tube, strip, film, vessel). In some examples, drug particles may have different sizes, shapes and forms.

As used herein, the term “bowl feeder” refers to a component or element of the dispensing unit configured to receive, temporary hold and feed drug particles to other components or elements (such as feeder track). In some examples, the bowl feeder contains a bowl that contains a bowl base, a bowl discharge port and a spiral bowl feeder, and the bowl feeder is configured to vibrate such that the drug particles are moved spirally upward along the spiral track.

As used herein, the term “feeder track” refers to a component or element of the dispensing unit configured to conduct or transport the drug particles from one component or element to another. In some examples, the feeder track operatively connects with the bowl feeder and discharge mechanism and the feeder track is configured to transport drug particles from the bowl feeder to the discharge mechanism.

As used herein, the term “discharge mechanism” refers to a component or element of the dispensing unit that discharge drug particles in the feeder track. In some examples, the discharge mechanism contains a driving cylinder and a pick.

As used herein, the term “blanking track” refers to a component or element of the dispensing unit which blanks or dispense drug particles from the dispensing unit.

As used herein, the term “medicine box” refers to a container that can at least temporarily hold or contain one or more drug particles. In certain examples, the medicine box contains one or more compartments to hold the drug particles. In certain examples, the multiple compartments are formed or defined by a middle body and two cover plates.

As used herein, the term “transportation mechanism” refers to a system or element configured to transport, accurate or move one or more medicine boxes (such as along a production line) to desired locations, such as at different components or modules in the dispensing system.

As used herein, the term “servo mechanism” refers to a system or element that contains servo motor to acuate and control relative position of a medicine box to a dispensing station. In some examples, the servo mechanism actuates and controls the relative position of each compartment to the dispensing station, such that drug particles required (e.g., in desired type and quantity) can be dispensed in the designated compartments.

As used herein, the term “automated guided vehicle (AGV)” refers to a mobile robot used to transport materials. In some examples, AGV is used to transport drug particles to be replenished from warehouse to the designated dispensing unit.

Although the description referred to particular embodiments, the disclosure should not be construed as limited to the embodiments set forth herein.

### Numbered Embodiments

Embodiment 1. An automated dispensing unit for drug particles, comprising a bowl feeder, comprising a bowl comprising a bowl base; a bowl discharge port; and a spiral bowl feeder track configured to connect between the bowl base and the bowl discharge port; a feeder track, comprising a feeder track inlet; and a feeder track outlet; a discharge mechanism, comprising a driving cylinder; and a pick; and a blanking track, comprising a blanking track inlet; and a blanking track outlet, wherein, when in operation, the bowl feeder is configured to vibrate such that the drug particles disposed in the bowl are moved upward towards the bowl discharge port along the spiral bowl feeder track, wherein the bowl discharge port is configured to operatively connect with the feeder track inlet, and the feeder track outlet is configured to operatively connect with the discharge mechanism, such that the drug particles from the bowl feeder are received and delivered to the discharge mechanism along the feeder track, and wherein the driving cylinder is configured to drive the pick to be movable between a first position that is juxtapose with the feeder track outlet and a second position that is juxtapose with the blanking track inlet, such that at least one drug particle is dispensed into the blanking track by the pick when the pick is moved from the first position to the second position.

Embodiment 2. The drug dispensing unit of embodiment 1, further comprises a plurality of sensors directed to the unit to monitor quantity of drug particles at different locations.

Embodiment 3. The drug dispensing unit of any of the preceding embodiments, wherein the plurality of sensors are photoelectric sensors that comprise: a first photoelectric sensor directed to the bowl base to monitor quantity of the drug particles inside the bowl; a second photoelectric sensor directed to the feeder track inlet to monitor quantity of the drug particles at the feeder track inlet; a third photoelectric sensor directed to the feeder track outlet to monitor quantity of the drug particles at the feeder track outlet; and/or a fourth photoelectric sensor directed to the blanking track outlet to monitor quantity of the drug particles at the blanking track outlet.

Embodiment 4. The drug dispensing unit of any of the preceding embodiments, wherein the feeder track is configured to vibrate to move the drug particles along the feeder track.

Embodiment 5. The drug dispensing unit of any of the preceding embodiments, further comprises a storage bin for storing a plurality of drug particles, wherein the storage bin is configured to open to deliver drug particles stored in the storage bin to the bowl feeder in response to a pre-defined quantity of the drug particles inside the bowl monitored by the first photoelectric sensor.

Embodiment 6. The drug dispensing unit of any of the preceding embodiments, wherein the bowl feeder is configured to vibrate in response to a pre-defined quantity of the drug particles monitored by the second photoelectric sensor.

Embodiment 7. The drug dispensing unit of any of the preceding embodiments, wherein the feeder track is configured to vibrate in response to a pre-defined quantity of the drug particles monitored by the third photoelectric sensor.

Embodiment 8. The drug dispensing unit of any of the preceding embodiments, further comprises a shell to enclose the bowl feeder, the feeder track and the discharge mechanism, wherein the shell comprises one or more of the following features: sound-proof, moisture-proof, dust-proof, light shielding and combination thereof.

Embodiment 9. The drug dispensing unit of any of the preceding embodiments, further comprises or operatively connects with a negative pressure air circulation filtration device to clean any dust pollution in the dispensing unit.

Embodiment 10. The unit of any of the preceding embodiments, wherein the feeder track has an adjustable plate for adjusting the width of the track.

Embodiment 11. An automated dispensing station for drug particles, comprising one or more drug dispensing units as embodimented in embodiment 1.

Embodiment 12. The drug dispensing station of embodiment 11, further comprising a frame comprising a drug collection layer at bottom, and one or more dispensing layers positioned above the drug collection layer, each dispensing layer is configured to house one or more drug dispensing devices.

Embodiment 13. The drug dispensing station of any of the embodiments 11 to 12, wherein individual dispensing layer comprises a dispensing pipe configured to deliver the drug particles dispensed from the one or more drug dispensing units to the drug collection layer.

Embodiment 14. The drug dispensing station of any of the embodiments 11 to 13, further comprising a station controller that is operatively connected with the one or more dispensing units and the plurality of photoelectric sensors.

Embodiment 15. The drug dispensing station of any of the embodiments 11 to 14, further comprises a servo mechanism configured to control relative position of a medicine box that comprises a plurality of compartments at the drug collection layer to receive the drug particles dispensed from the one or more drug dispensing units to a designated compartment of the medicine box.

Embodiment 16. A system for automated dispensing of drug particles, comprising a plurality of dispensing stations as embodiment 11; a plurality of medicine boxes, configured to receive drug particles dispensed from at least one dispensing station; a transportation mechanism, operatively connected with the plurality of dispensing stations and configured to transport one or more of the medicine boxes to at least one of the plurality of dispensing stations to form a production line; and a central control unit, configured to control operation of the system, wherein one or more designated medicine boxes are transported along the production line, and one or more designated drug particles are dispensed from one or more designated dispensing stations and collected in the one or more designated medicine boxes, in response to one or more input instructions.

Embodiment 17. The system of embodiment 16, further comprising a visual inspection module configured to receive a medicine box and verify type and quantity of the drug particles in the medicine box.

Embodiment 18. The system of any of the embodiments 16 to 17, further comprising a packaging module configured to package dispensed drug particles as packaged drugs, and print at least one label thereon.

Embodiment 19. The system of any of the embodiments 16 to 18, wherein the packaging module comprises a packaging material supply device, an information printing device, and an automated packaging device.

Embodiment 20. The system of any of the embodiments 16 to 19, further comprising a cleaning module configured to clean the medicine boxes and the production line.

Embodiment 21. The system of any of the embodiments 16 to 20, wherein the cleaning module comprises a cleaning nozzle, a cleaning agent supply system, and a vacuum device, wherein the cleaning nozzle is configured to connect with the cleaning agent supply system to apply a cleaning agent from the cleaning agent supply system to the production line and/or medicine boxes after use for cleaning, and wherein the vacuum device is configured to remove any residues and dust after cleaning.

Embodiment 22. The system of any of the embodiments 16 to 21, wherein the medicine box comprises a plurality of compartments, wherein each of the dispensing station further comprises a servo mechanism configured to control relative position of the medicine box in the drug collection layer to receive the drug particles dispensed from the one or more drug dispensing units to a designated compartment of the medicine box.

Embodiment 23. The system of any of the embodiments 16 to 22, wherein the medicine box further comprises two cover plates and a medicine box body sandwiched therebetween to form the plurality of compartments, wherein the medicine box body defines a plurality of cavities, the cover plates are respectively configured to be switchable between at least an open position and a closed position relative to medicine box body, wherein at the open position, one or more compartments are exposed, and at the closed position, one or more compartments are covered.

Embodiment 24. A method of automatedly dispensing drug particles, comprising the steps of: providing a system as embodiment 17; processing a prescription information to form an input instruction, and binding the input instruction to a designated medicine box; transporting the designated medicine box along the production line to one or more designated dispensing stations; and dispensing the designated drug particles from the one or more designated dispensing stations to the designated medicine box in response to the input instruction, until all drug particles in need are collected in the designated medicine box.

Embodiment 25. The method of embodiment 24, further comprising the step of: conducting a first visual inspection on the drug particles to verify type and quantity of drug particles in the medicine box based on the input instruction.

Embodiment 26. The method of any of the embodiments 24 to 25, further comprising the step of: packaging drug particles to form one or more packaged drug particles with one or more printed labels in response to the input instruction.

Embodiment 27. The method of any of the embodiments 24 to 26, further comprising the step of: conducting a second visual inspection on the packaged drug particles to verify type and quantity of drug particles in the medicine box based on the input instruction.

Embodiment 28. The method of any of the embodiments 24 to 27, further comprising the step of: cleaning the medicine box and/or the production line after use.

Embodiment 29. The method of any of the embodiments 24 to 28, further comprising the step of: determining quantity of each type of drug particles in the system is below a corresponding pre-defined threshold; if confirmed, replenishing drug particles in need to a designated dispensing station until the quantity is equals to or above the pre-defined threshold.

Embodiment 30. The method of any of the embodiments 24 to 29, wherein the step of replenishing the drug particles to the designated unit of the station comprises the step of: delivering drug particles by an AGV to the designated dispensing station.

### EXAMPLES

Provided herein are examples that describe in more detail certain embodiments of the present disclosure. The examples provided herein are merely for illustrative purposes and are not meant to limit the scope of the invention in any way. All references given below and elsewhere in the present application are hereby included by reference.

### Dispensing Units

### Example 1

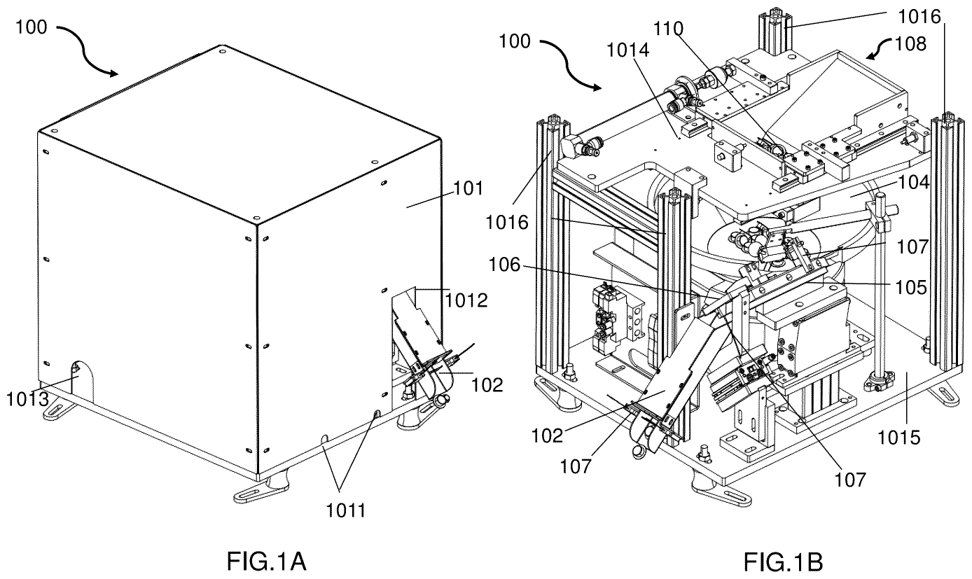

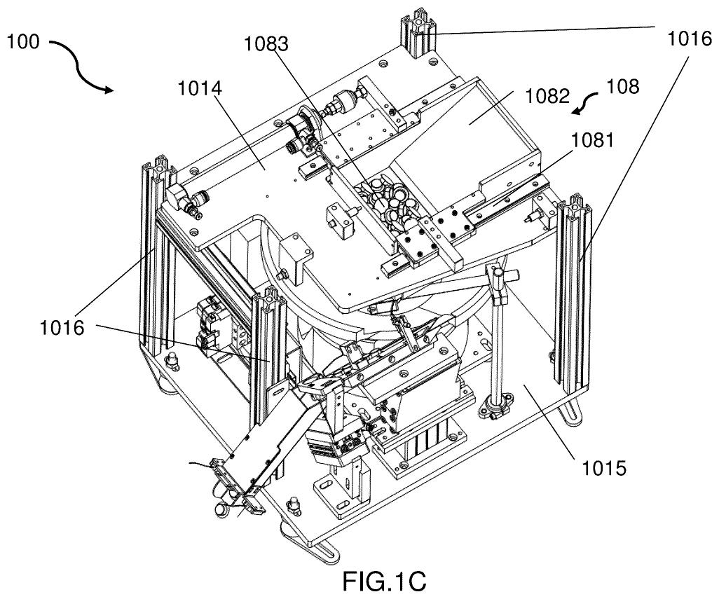

FIGS. 1A-1C showed an example dispensing unit 100. FIG. 1A showed the example dispensing unit 100, which contains a shell 101 to wrap most of the internal structures or mechanisms of the dispensing unit 100. The shell 101 shell encloses the internal structures such as a vibratory bowl feeder, a direct feeder track and a discharge mechanism, which will be described in more detail later. The shell 101 is made of materials that contains one or more of the following features: sound-proof, moisture-proof, dust-proof, light shielding and combination thereof. The shell 101 has certain ports such as a blanking track port 1012 for exposing only a partial portion of a blanking track 102 (including a blanking track outlet), control cable ports 1011 for control cables to extend therefrom and a negative pressure air circulation pipe port 1013 for connecting with an external, negative pressure air circulation air circulation filtration system (not shown) to avoid any dust pollution. The rest of the portions of the shell 101 are completely closed to ensure that the internal structures or mechanisms of the entire dispensing unit 100 is not polluted by the external environment. In some examples, the negative pressure air circulation air circulation filtration system is operatively controlled by a controller or controlling system.

FIGS. 1B-1C showed the internal components of the dispensing unit 100, after the shell 101 is removed. The dispensing unit 100 generally contains a vibratory bowl feeder 104, a direct feeder track 105, a discharge mechanism 106, a blanking track 102, a storage bin 108, and sensors 107. These internal components are supported by a top supporting plate 1014 and a bottom supporting plate 1015, which are fixed by four vertical pillars 1016. The storage bin 108 is installed on the top supporting plate 1014, on top of the vibratory bowl feeder 104. FIG. 1C shows the charging situation of storage bin 108. The storage bin 108 contains a movable track 1081 in the upper part of storage bin 108, and a replenishment bin 1082 which is configured to be extendable to the outside of the dispensing unit 100 along the movable track 1081, so as to receive supplementary drug particles from external source (e.g., from an automated guided vehicle (AGV)) to the filler bin 1083 of the storage bin 108. The filler bin floor (not shown) at the top supporting plate is configured to be opened so that the drug particles stored in the filler bin 1083 can be dropped into and added (or replenished) to the vibratory bowl feeder 104. In this example, the movable track 1081 is driven by a pneumatic system (not shown). In other examples, other suitable driving systems such as stepper motors, hydraulic or electric actuators may be used instead. In some examples, the overall operations of the dispensing unit 100, including actuating the vibratory bowl feeder 104, the direct feeder track 105, the discharge mechanism 106, the blanking track 102, the storage bin 108, and the sensors 107 are under control by a controller or controlling system contained by or operatively connected with the dispensing unit.

### Example 2

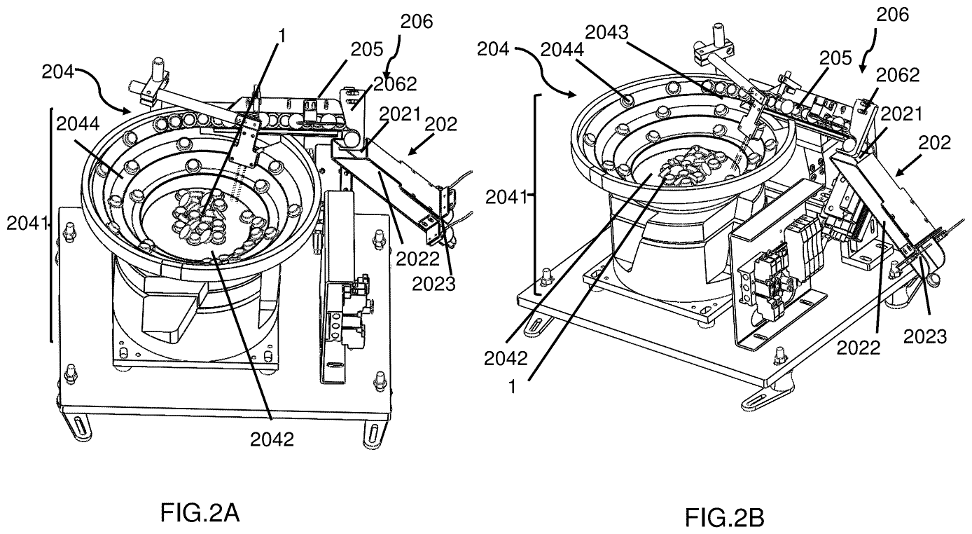

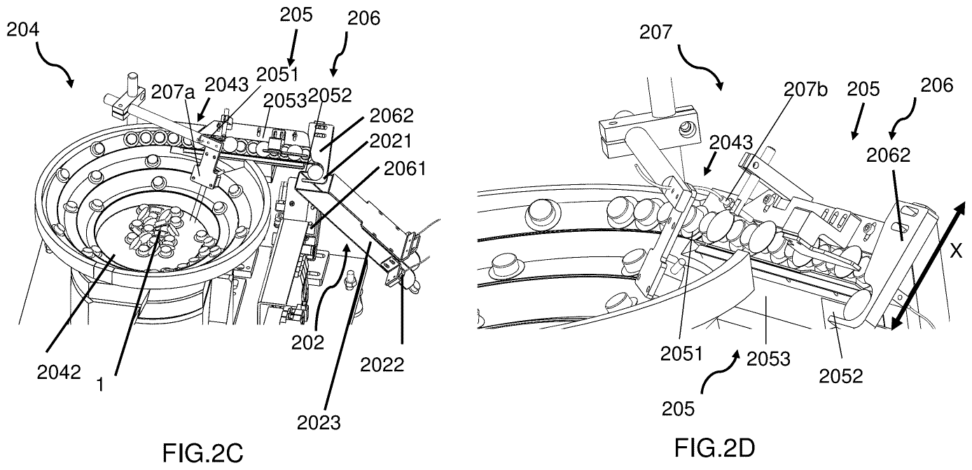

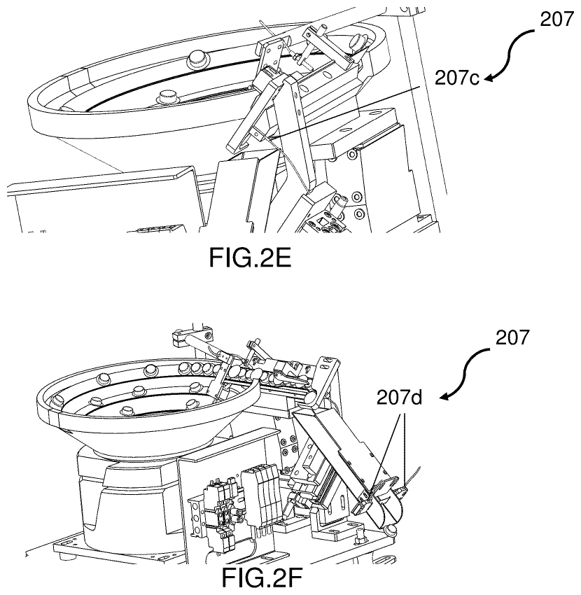

Now referring to FIGS. 2A-2F, showing certain internal components of the dispensing unit 200, after the shell, the top supporting plate, and the storage bin are removed. The dispensing unit 200 generally contains a vibratory bowl feeder 204, a direct feeder track 205, a discharge mechanism 206 (with a pick 2062 positioned at the second position in this figures), a blanking track 202, which are operatively connected together sequentially. The dispensing unit 200 also contains multiple sensors 207. The dispensing unit 200 contains or operatively connects with a controller and/or a processer to control the overall operation of various internal components or mechanisms of the dispensing unit 200.

The vibratory bowl feeder 204 contains a bowl 2041 to feed (including receive, temporarily retain and transport) the drug particles to the spiral bowl feeder track 2044. The bowl 2041 contains a bowl base 2042, a bowl discharge port 2043, and a spiral bowl feeder track 2044. The spiral bowl feeder track 2044 is spirally and circumferentially arranged on the inner wall of the bowl 2041. The spiral bowl feeder track 2044 is configured to connect between the bowl base 2042 and the bowl discharge port 2043, and is sized and shaped to allow the drug particles to be retained and transported along the spiral bowl feeder track 2044. When in operation, the spiral bowl feeder track 2044 is configured (e.g., by a bowl feeder vibrator or actuator) to vibrate (e.g., rotationally vibrate) such that the drug particles 1 disposed or retained at the bowl base 2041 are gradually moved upward, one followed by another, from the bowl base 2042 towards the bowl discharge port 2043, along the spiral bowl feeder track 2044. In this example, drug particles 1 are in the form of packaged cylindrical disc shaped pellets. In other examples, drug particles can be in other forms, sizes and shapes, with or without packaging. The width and length of the spiral feeder track can be adjusted according to the sizes and shapes of the drug particles. In other examples, the bowl feeder 204 is configured to use other forms of actuation (e.g., rotary movements such as swirling), mechanical vibrations or other means to create centrifugal force to convey drug particles upward along the spiral bowl feeder track 2044. Moving the drug particles upward (instead of downward) minimizes the chances of crushing of the drug particles, especially naked drug particles (such as solid pellets), which may be prone to crushed into pieces or powders during vibration.

Now referring to FIGS. 2C and 2D, the direct feeder track 205 contains a feeder track body 2053, a feeder track inlet 2051 and a feeder track outlet 2052, and direct feeder track 205 is sized and shaped to receive the drug particles side by side along the feeder track body 2053. The feeder track inlet 2051 is disposed adjacent to the bowl discharge port 2043 and is configured to operatively connect with the bowl discharge port 2043, such that when in operation, the drug particles 1 conveyed along the vibratory bowl feeder 204 are subsequently received and delivered to the direct feeder track 205 (i.e., from the bowl discharge port 2043 to the feeder track inlet 2051). The direct feeder track 205 optionally contains an adjusting plate for adjusting the dimensions (e.g., the width) of the direct feeder track 205, which can adapt to different drug particle sizes and shapes. In this example, when in operation, the direct feeder track 205 is configured to actuate or vibrate (e.g., linearly or rectilinearly vibrate) to facilitate the longitudinal movement of the drug particles 1 along the direct feeder track 205 (from the feeder track inlet 2051 towards the feeder track outlet 2052). In other examples, the direct feeder track 205 is not configured to actuate or vibrate per se. The drug particles 1 are passively received and delivered to the direct feeder 205 track from the vibratory bowl feeder 204 when the drug particles 1 are continually fed into the direct feeder track 205.

The discharge mechanism 206 generally contains a driving cylinder 2061 and a pick 2062. The feeder track outlet 2052 of the direct feeder track 205 is operatively connected with the discharge mechanism 206, such that the drug particles 1 from the direct feeder track 205 are received and delivered to the discharge mechanism 206. The pick 2062 is configured to be switchable between at least two positions: a first position that is juxtapose with the feeder track outlet 2052 and a second position that is juxtapose with the blanking track inlet 2021 of a blanking track 202, under the control of the driving cylinder 2061. The pick 2062 has a drug particle receiving portion being sized and shaped to receive a drug particle. In this example, the pick 2062 is in the form of a hook. When in operation, the driving cylinder 2061 is configured to controllably drive the pick 2062 to be reciprocally movable between the first position and the second position, in a direction indicated by the indicated by double-headed arrow X. In this example, the driving cylinder 2061 performs reciprocating linear motion, and drives the pick 2062 to perform synchronous reciprocating linear motion in the direction of X. To ensure the accuracy and stability of the discharge mechanism 206, the driving cylinder 2061 was used to push the direct feeder track 205 in the form of a sliding block. This type of mechanism has a simple structure, robust work and easy for maintenance. A drug particle originally positioned at the feeder track outlet 2052 is delivered and dispensed into the blanking track 202 by the pick 2062, when the pick 2062 is moved from the first position to the second position. Continually and/or repeatedly switching the pick 2062 between the first position and the second position will allow the pick 2062 to deliver and dispense drug particles 1 to the blanking track 202 one by one.

Now referring to FIGS. 2A, 2B, 2C and 2D, the blanking track 202 generally contains a blanking track body 2023, a blanking track inlet 2021 and a blanking track outlet 2022. The blanking track 202 is positioned beneath the second position and is configured to receive the drug particle 1 moved by the pick 2062 at the second position. At the second position, the drug particle 1 received by the pick receiving portion is dropped into the blanking track inlet 2021. In this example, the blanking track body 2023 is a generally rectangular, slant channel with an internal size sufficient to receive a drug particle 1. The drug particle 1 dropped and received in the blanking track inlet 2021 then can be subsequently transported to the blanking track outlet 2022 along the blanking track body 2023. The drug particle then is dispensed from the dispensing unit.

Now referring to FIGS. 2C, 2D, 2E and 2F, one or more sensors (generally referred as 207) directed to the dispensing unit at various positions are optionally provided to monitor quantity of drug particles at different locations. For example, in order to ensure accurate counting of the drug particles 1 to be dispensed, one or more sensors 207 were used to count the drug particles 1 at the direct feeder track 205. In this example, the one or more sensors are photoelectric sensors 207a-d. In this example, the photoelectric sensors includes a first photoelectric sensor 207a directed to the bowl base 2042 to monitor quantity of the drug particles 1 inside the bowl, a second photoelectric sensor 207b directed to the feeder track inlet 2051 to monitor quantity of the drug particles 1 at the feeder track inlet 2051, a third photoelectric sensor 207c directed to the feeder track outlet 2052 to monitor quantity of the drug particles 1 at the feeder track outlet 2052; and a fourth photoelectric sensor 207d directed to the blanking track outlet 2022 to monitor quantity of the drug particles 1 at the blanking track outlet 2022. In other examples, other suitable sensors such as optical sensors, weight sensors, capacitive sensors, inductive sensors, ultrasonic sensors, magnetic sensors, and/or camera-based vision systems may be used at the same or different locations instead.

In this example, the dispensing unit is provided with the vibratory bowl feeder 204 and the storage bin (such as storage bin 108 in Example 1 and FIGS. 1B and 1C), to ensure that more drug particles 1 can be dispensed at one time and the drug particles 1 will not be vibrated in the vibratory bowl feeder 204 for a long period of time to avoid crushing. For example, certain amounts of drug particles 1 were placed in the vibratory bowl feeder 204 and the storage bin in advance, respectively, and when in operation, the dispensing unit dispenses the drug particles 1 placed in the vibratory bowl feeder 204 first. When the sensor 207 such as the first photoelectric sensor 207a detects that the number of drug particles 1 in the vibratory bowl feeder 204 equals to or below a pre-defined quantity (e.g., close to being used up), the storage bin is configured to open through an automatic opening mechanism, and the drug particles 1 stored in the storage bin will automatically fall into the vibratory bowl feeder 204, thus completing the automatic refill operation. In order to ensure that the vibratory bowl feeder 204 can be automatically replenished when there are drug particles 1 in it, the first photoelectric sensor 207a is set to monitor the quantity of the drug particles 1 in the vibratory bowl feeder 204 in real time. When the quantity of the drug particles 1 reaches the pre-defined threshold (i.e., minimum limit), the storage bin will be opened according to the feedback of the first photoelectric sensor 207a for automatic replenishment.

In some examples, the dispensing unit (such as dispensing unit 100 in Example 1 and FIGS. 1A to 1C) contains a unit controller, or a controlling system which controls the whole device through pre-set programs to coordinate the work, so as to achieve the purpose of automatic dispensing of drugs. By way of examples, the controller is a microcontroller, a processor, and/or a software program that operatively connects with various components in the dispensing unit (such as the vibratory bowl feeder, the direct feeder track, the discharge mechanism, the blanking track, storage bin and the sensors) to control the overall operation of each component, in order to ensure the accuracy and stability of automatic dispensing of drugs. In some other examples, the dispensing unit does not contain a standalone unit controller, but operatively connects with an external controller or controlling system which controls the dispensing unit as well as other dispensing units, dispensing stations and/or dispensing systems.

### Dispensing Stations

In some examples, one or more drug dispensing units as described herein are operatively connected with each other to form an automated dispensing station for drug particles. In some examples, a dispensing station generally contains multiple dispensing units, a rack or frame, optionally one or more station controllers, and one or more sensors. More details of the dispensing station will be described.

### Example 3

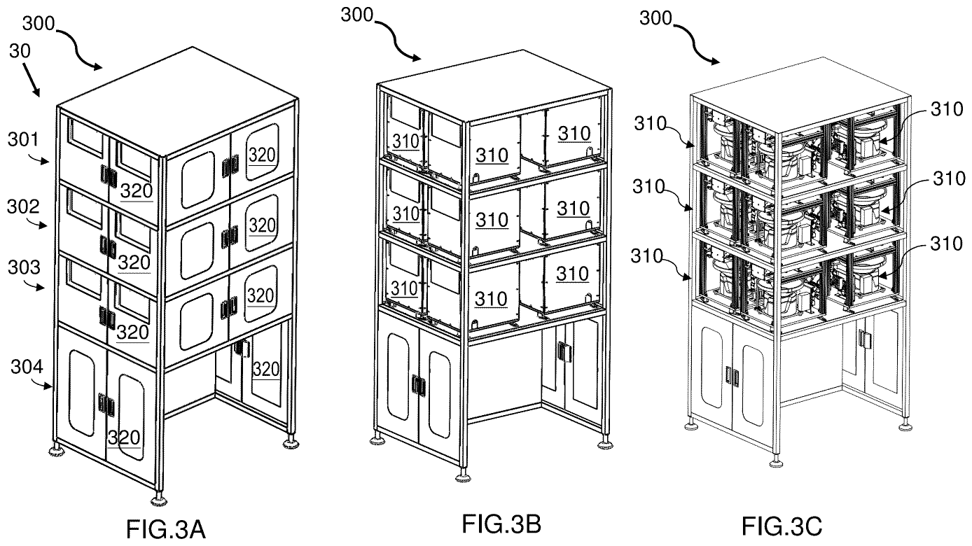

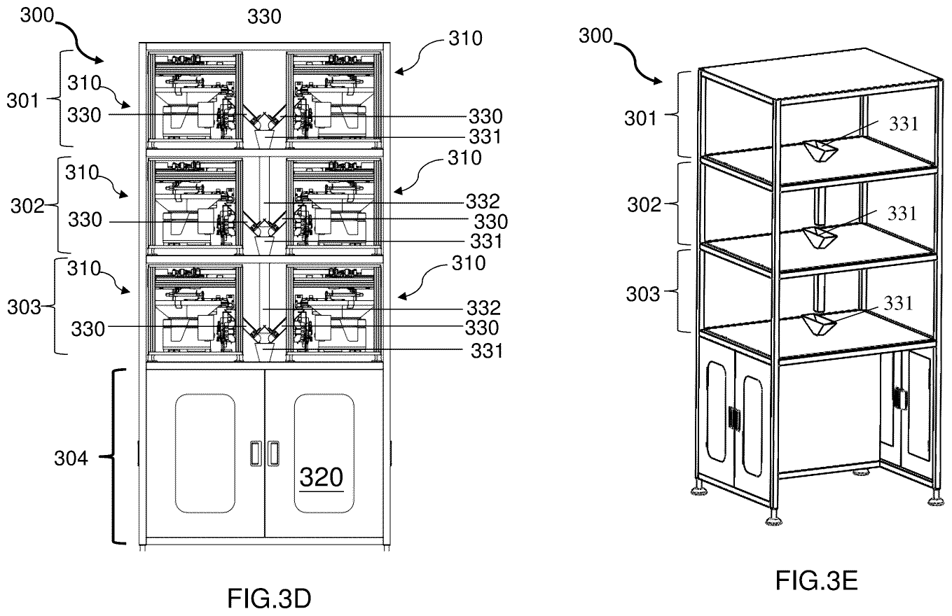

Now turning to FIGS. 3A-3E, showing an example dispensing station 300. FIG. 3A showed the overall appearance of the dispensing station 300, which contains a multiple layered rack (or a frame) 30, to accommodate multiple dispensing units at predefined positions respectively. In this example, the rack 30 is in the form of a cabinet with multiple (four) platform layers (FIG. 3A). In this example, each layer of the rack 30 and the dispensing units 310 are provided with isolation pads. One or more of the four sides of the bottom layer 304 contains double doors 320 for accessing internal space within the bottom layer 304, which is the drug particles collection layer. The first layer 301, the second layer 302, and the third layer 303 are provided above the bottom layer 304 sequentially, each contains a space for receiving and accommodating 4 dispensing units 310 in 2×2 array arrangement. In other words, in this example, the dispensing station totally contains 12 dispensing units to dispense 12 different types of drug particles. In other examples, different number of layers (e.g., 1, 2, 3, 4, 5, 6, 7, 8, 9, 10 or more), different number of dispensers (e.g., 1, 2, 3, 4, 5, 6, 7, 8, 9, 10, 11, 12, 13, 14, 15, 16, 17,18, 19, 20, 21, 22, 23, 24, 25, 26, 27, 28, 29, 30 or more) or different arrays (e.g., 3×3, 3×2, 4×4, 4×3, 4×2, 4×1, etc.) or different arrangements of the dispensing units 310 are provided in a dispensing station 300. in this example, one or more of the four sides of each layer contains double doors 320 for accessing internal space within the respective layer. FIG. 3B showed the dispensing station 300 with double doors on the four sides of each layer removed, to show the dispensing units 310 with the shells. In this example, the dispensing units 310 accommodated at one side of the dispensing station 300 are disposed such that the replenishment bin of each dispensing unit 310 are directed towards the same side of double doors 320 dispenser station. FIG. 3C showed the dispensing station with double doors 320 on the four sides of each layer and the shells of the dispensing units 310 removed. FIG. 3D showed the dispensing station 300 with double doors 320 on the four sides of each layer and the shells of the dispensing units 310 removed, showing the dispensing pipe 330 in each of the first 301, second layer 302 and third layer 303. The middle layers (the second 302 and the third layers 303) also contain a connection pipe 332 to connect the funnels 331 between different adjacent layers. The funnels 331 in each layer receive and drop any drug particles dispensed from the blanking track outlets of the blanking tracks of the dispensing units 310 accommodated in the layer. As such, the drug particles dispensed from any one or more of the dispensing units 310 in the dispensing station 300 can be dropped and transferred to the bottom layer 304. The front double doors 320 for the bottom layer 304 is closed. FIG. 3E showed the dispensing station with double doors 320 on the four sides of each of the first layer 301, second layer 302 and third layer 303, the dispensing units 310 and the dispensing pipe 330 removed, showing the funnel 331 in each of the first 301, second layer 302 and third layer 303. In other examples, other formats of doors may be provided instead.

At the bottom layer of the dispensing station 300, a servo mechanism (not shown) is provided and configured to receive and actuate a medicine box from a production line, to control relative position of a medicine box at the bottom layer 304 to receive the drug particles dispensed from the one or more drug dispensing units 310 to a designated location, e.g., a designated compartment of the medicine box. In this example, the servo mechanism is a multi-axis servo mechanism to actuate the medicine box in defined axes, for example, under the control of a controller or controlling system, such that the drug particles can be dispensed in the designated compartments in the medicine box.

### Dispensing Systems

In some examples, one or more drug dispensing stations as described herein are provided as a production line to form a dispensing system. In some examples, the production line is provided in the form of a transportation mechanism such as a conveyor belt system. In some examples, a dispensing system generally contains multiple dispensing stations, multiple medicine boxes, a transportation mechanism, and a central control unit.

### Example 4

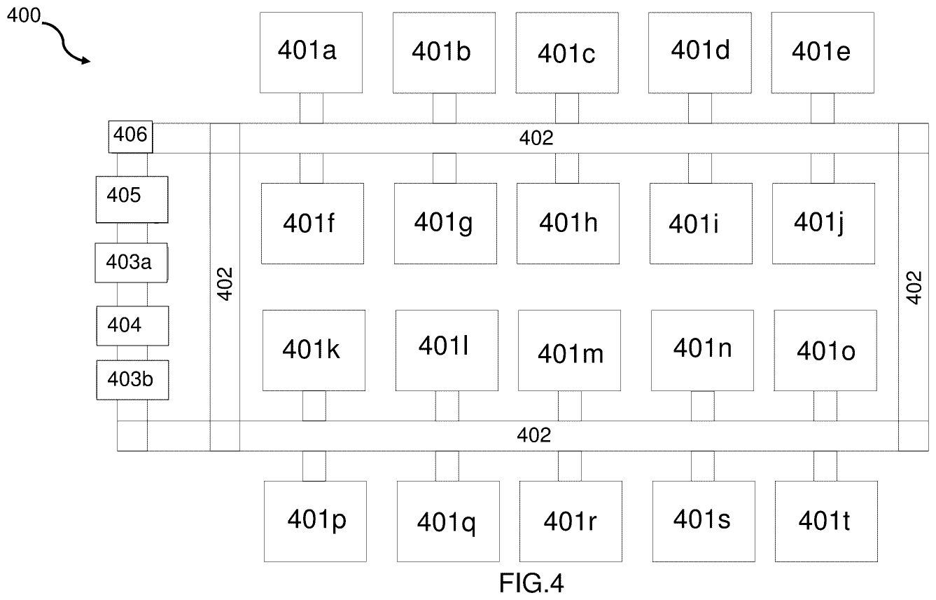

FIG. 4 showed an overall layout of an example dispensing system 400. In this example, the system 400 contains 20 dispensing stations 401a-t (generally referred as 401), and a transportation mechanism (in the form of a circulating production line 402) that is operatively connected with the dispensing stations 401a-t and configured to transport one or more medicine boxes (not shown) between these dispensing stations 401a-t. The production line 402 is configured to transport one or more medicine boxes which are delivered to designated locations (e.g., dispensing stations 401a-t) to receive drug particles required. The entire production line adopts a modular design, and the length and the size of the production line and the number of dispensing stations can be adjusted (e.g., increased or decreased) according to the specific types and quantity of dispensing drugs required. By adopting a modular design approach, the production line 402 operates flexibly without being limited by the types and quantities of dispensing drugs required. At the same time, production line 402 is flexibly arranged according to the actual situation of the production site 402, maximizing the utilization rate of the overall equipment. The production line 402 and dispensing stations 401a-t are controlled through a unified central control system (not shown), ensuring coordinated work between them. In this example, the dispensing system 400 also contains a further post-dispensing, transportation mechanism operatively connects with the production line 402 and contains a first visual inspection module 403a, a packaging module 404, a second vision inspection module 403b, and a medicine box cleaning module 405 for inspection, packaging and cleaning purposes. The dispensing stations 401 automatically dispense drug particles to be dispensed into the medicine box. Each dispensing station 401 contains multiple independent dispensing units, each of which is equipped with an intelligent discharging mechanism that can accurately control the discharging speed and quantity according to an input instructions under control of controller or controlling system.

The first and second visual inspection modules 403a-b comprehensively utilize image vision detection technology to conduct comprehensive and accurate detection of drug particles, including an appearance detection unit and a quantity detection unit. The appearance detection unit uses image recognition technology to detect the appearance integrity, shape, and color of the drug, ensuring that drug particles are undamaged and have correct shape and color, while quantity detection unit confirms the dispensed quantity of the drug particles through image recognition technology to detect the quantity of drug particles dispensed. When the first and second visual inspection modules 403a-b detect that the drug is unqualified (e.g., damaged or incorrect type of drug particles) or the quantity is incorrect, the central control unit controls the visual detection module to mark the unqualified drug and inform the system of the location of the unqualified drug for feedback.

The packaging module 404 performs packaging operations on drug particles that have been tested and found to be qualified, after the visual inspection by the first visual inspection module 403a. In some examples, the packaging module 404 is equipped with a packaging material supply device, an information printing device and an automated packaging device. The packaging material supply device provides corresponding packaging materials according to the packaging needs of different drug particles. The information printing device will print patient information and drug particles information required by the patients onto the packaging surface. The automated packaging device is configured to efficiently and accurately package qualified drug particles and can adapt to various types of drug particles and independently package them, ensuring the accuracy and aesthetics of packaging. The automated packaging device can adjust the packaging speed and packaging specifications according to the input instructions controlled by the central control unit, and can be used for streamlined packaging operations on the production line.

The cleaning module 405 is configured for cleaning the medicine boxes. In one example, the cleaning module 405 includes one or more cleaning nozzles, a cleaning agent (e.g., disinfecting gas, solution or liquid) supply system, a vacuum cleaning device and optionally a UV sterilization device. The cleaning module 405 is configured to deeply clean the medicine boxes on the production line 402 to ensure the cleanliness of the medicine boxes, such as before or after use. In some examples, the cleaning module 405 is configured to automatically start a preset cleaning program (e.g., under control by the central control unit) to clean the medicine box, ensuring the cleanliness and hygiene standards of the medicine box. In other examples, other suitable disinfecting means or systems may be used instead.

In some examples, the dispensing system 400 achieves intelligent coordinated control through a central control unit, greatly improving the dispensing accuracy, efficiency, and safety of solid medicine particles, and providing reliable technical solutions for drug production and logistics. In some examples, the central control unit contains a data analysis module and fault diagnosis function module, which can monitor the operation data of the production line in real time, warn potential faults and provide possible solutions. In some examples, the central control unit is operatively connected with the production line 402, the dispensing stations 401a-t, and all other modules such as the visual inspection modules 403a-b, the packaging module 404, and the cleaning module 405 for precise coordination and control of the operating status and parameters of each part.

By way of examples, each of the dispensing unit contains its independent unit controller, and/or individual dispensing station 401 contains a station controller to control the overall operating status of each of the dispensing units accommodated in this dispensing station 401. The unit controller and/or station controller is operatively connected with the system controller of the dispensing system 400. In other words, in these examples, the dispensing units, the dispensing stations and the dispensing systems contain their own independent controllers or controlling systems, respectively. The controlling system or system controller of the dispensing system 400 operatively connects with the station controllers and/or unit controllers and controls the overall operation of the dispensing units, the dispensing stations 401a-t and the dispensing system 400. In other examples, unit controllers and/or station controllers are not provided in the dispensing units and/or dispensing stations, a central control unit is configured to control all the operations of the at least some or all of the components of the dispensing units, the dispensing stations 401a-t and/or the dispensing system 400.

In some examples, the controlling system or system controller of the dispensing system 400 contains or operatively connects with a processor or a server to process any manage any data, a database to store data such as patient information, inventory level, visual features of each drug particles in dispensing units, dispensing station, dispensing systems and/or warehouse.

When the medicine box enters the production line at the starting position (start & end module 406), a scanning device provided at the start & end module 406 is configured to scan a unique identifier (e.g., a unique barcode or QR code) corresponding to a medicine box, to temporarily bind the medicine box with a patient information, and to determine the input instructions including the type and quantity of drug particles that need to be dispensed in each storage compartments of the medicine box. Then, the medicine box is transported along the production line 402 and enters the corresponding dispensing stations 401a-t to load or dispense the drug particles according to the input instructions. Such binding can be removed or erased after the medicine box is used.

In some examples, before entering each dispensing station 401a-t, the medicine box goes through a scanning device. The scanning device is used to scan the barcode on the medicine box to determine whether the medicine box needs to be loaded from the corresponding dispensing station 401a-t. If there are drug particles in the dispensing station 401a-t that needs to be dispensed, the medicine box will enter the designated dispensing station 401a-t for loading. If there are no drug particles in the dispensing station 401a-t that needs to be dispensed, the medicine box is configured to enter the next dispensing station 401a-t along the production line and be scanned by the scanning devices provided at various locations on the production line for confirmation. The entire scanning and entry process will continue until the medicine box is filled with all the drug particles required by the patient according to the input instructions.

### Example 5

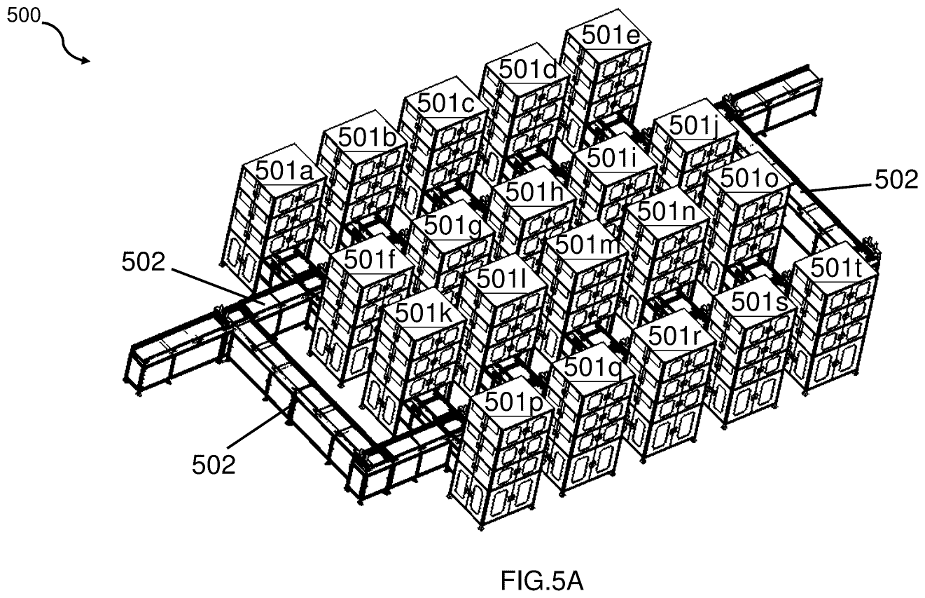

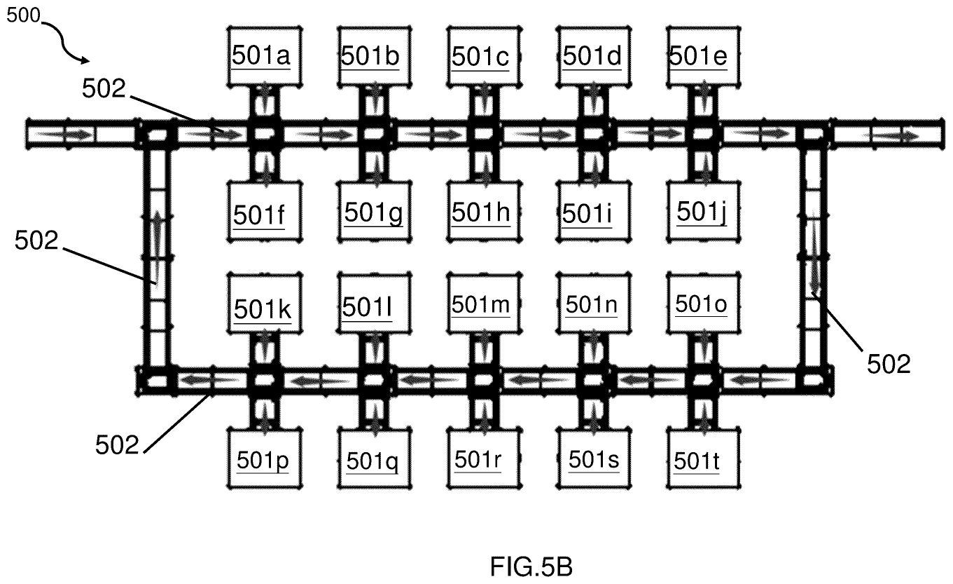

FIG. 5A showed another example dispensing system 500 and FIG. 5B showed the movement routes (indicated as arrows) of one or more medicine boxes (not shown) on the production line of the example dispensing system 500. In this example, dispensing system 500 contains 20 dispensing stations 501a-t (arranged in an array of 5 columns x 4 rows), a transportation mechanism 502 which is a circulating conveyor belt, operatively connected with dispensing stations 501a-t and configured to transport one or more medicine boxes to at least one of dispensing stations 501a-t (in other words, to enter and exit the bottom layer of the dispensing stations) to form a production line; and a central control unit, configured to control operation of the entire dispensing system 500, wherein one or more designated medicine boxes are transported along the production line, and one or more designated drug particles are dispensed from one or more designated dispensing stations 501a-t and collected in the one or more designated medicine boxes, in response to one or more input instructions. One or more medicine boxes are placed and moved on the circular production line 502 or, concurrently or separately, and configured to enter each dispensing station that needs to be dispensed with drug particles under control of a controller or controlling system. After the medicine boxes have filled all the drug particles in need respectively, they will exit the production line 502. In some examples, the exited medicine boxes then enter the subsequent visual inspection modules, packaging module and medicine box cleaning module to complete the corresponding post-dispensing operations, such as those described in Example 4.

### Medicine Boxes

In some examples, the dispensing systems as described herein contains medicine boxes to receive the dispensed drug particles from the dispensing units of the dispensing stations on the production line. In some examples, medicine boxes contain multiple compartments which can separately store the drug particles that patients need to take each time or dose, which facilitates the packaging and labelling of the dispensed drug particles in separate packets, effectively avoiding the occurrence of medication errors by the patients. In some examples, the medicine boxes operatively work with any one of the dispensing units, dispensing stations or dispensing systems as described herein.

In some examples, the medicine box mainly includes three parts: an upper cover, a middle body having various compartments, and a lower cover. The middle body is sized and shaped to be sandwiched between the upper cover and the lower cover. Each of the upper cover and the lower cover (generally referred as “covers”) is configured to be movable or slidable between an open position and a closed position so as to expose or cover one or more (or all) of the compartments at the upper side and the lower side, respectively. The middle body defines one or more cavities. The one or more cavities together with the upper cover and the lower cover form the one or more compartments for accommodating the dispensed drug particles, when they are at their respective closed positions. In some examples, when the upper cover is configured at the open position, the medicine box allows drug particles to be dropped into the compartments; when the lower cover is configured at the open position, the dispensed drug particles in the compartments are dropped from the compartments.

### Example 6

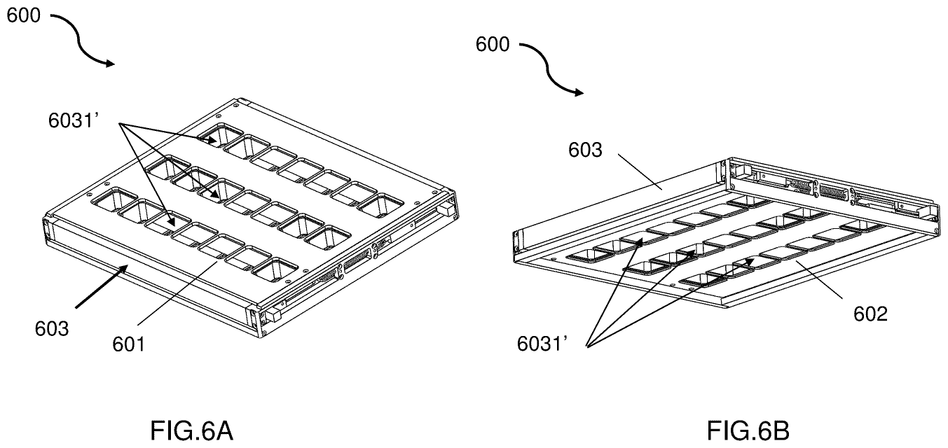

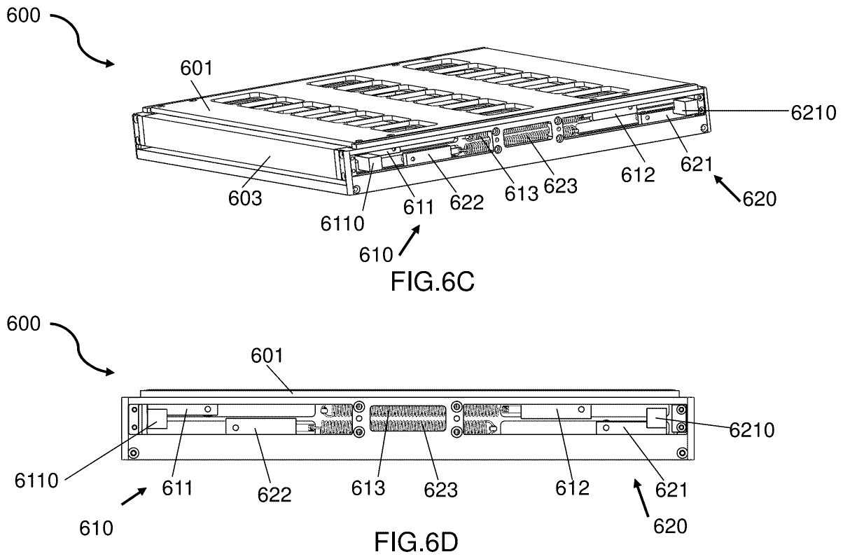

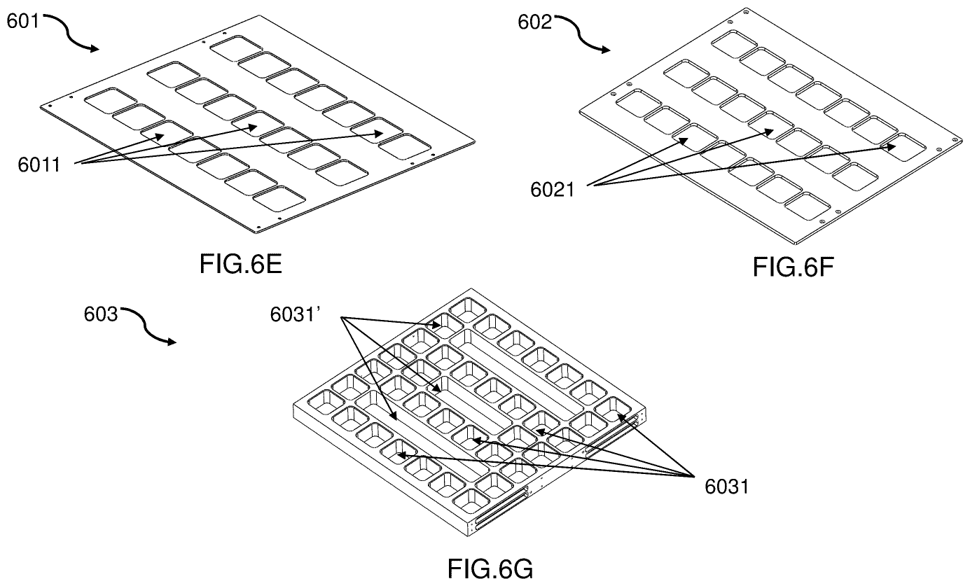

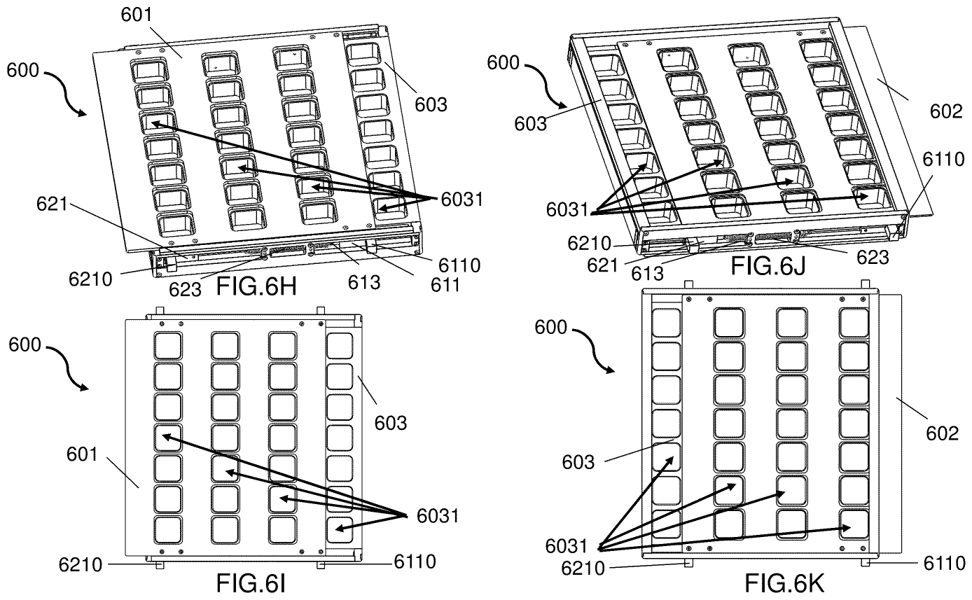

Now referring to FIGS. 6A-6K. In this example, the medicine box 600 generally contains an upper cover 601 (FIG. 6E), a lower cover 602 (FIG. 6F) and a middle body 603 (FIG. 6G) sandwiched between the upper cover 601 and the lower cover 602. In this example, the upper cover and the lower cover are thin plates that serve as an upper cover plate 601 and a lower cover plate 602 (generally referred as “cover plates”) for the middle body 603, respectively. The cover plates 601 and 602 are slidably connected with the middle body 603. In this example, the middle body 603 serves as a medicine box body 603. In this example, the cover plates are made of hard materials such as metals or alloys (e.g., stainless steel materials) and the main structure of the middle medicine box body 603 is made of medically environmentally friendly materials such as non-toxic, biodegradable polymers or plastics. The medicine box body 603 is thicker than the cover plates (601 and 602) and serves as the main body of the medicine box 600, used to hold the dispensed dispensing drugs. A medicine box driving mechanisms are provided to operatively connected to the upper cover plate 601 and lower cover plate 602, which are set on the upper and lower sides of the medicine box 600, and can be driven by an upper driving handle 6110 and a lower driving handle 6210 (collectively referred as “driving handles”) to translate and open or close the upper and lower cover plates, respectively. The main body 603 of the medicine box 600 in the middle has multiple cavities 6031, which will form multiple compartments to hold the dispensed solid medicine particles when either or both of the cover plates are in the closed position (e.g., at least the lower cover plate 602 is in the closed position). In this example, an array of 4 rows×7 columns (i.e., totally 28) of compartments are provided in the middle body 603. Additional cavities 6031′ with different sizes and shapes are provided to minimize the overall weight of the medicine box 600. In this example, 3 rows of additional cavities 6031′ in various sizes and shapes are provided between the 4 rows of compartments. Both the cover plates define multiple throughbores 6011 and 6012 respectively, such that when either or both of the cover plates are at the closed position, respectively, the cover plates cover at least some of the cavities 6031 to form the compartments, and when either or both of the cover plates are at the open position, the cover plates expose at least some of the cavities. In this example, a corresponding array of 3 rows×7 columns (i.e., totally 21) of throughbores 6011 and 6012 are defined in each of the cover plates such that 28 compartments are formed and exposed when at least the lower cover plate 602 is in the closed position. These compartments form independent storage spaces with the cover 602 plates, each of the compartments is configured to hold the drug particles in the amount that the patient needs to take at once (i.e., per dose). In other examples, different (array) arrangements, numbers, sizes and/or shapes of the compartments, cover plates and/or middle body can be used instead.

FIGS. 6A-6D showed the medicine box 600 with both of the cover plates 601 and 602 at the closed positions. Cavities 6031′ which are not configured to form compartments for drug particles are exposed, while cavities 6031 which are configured to form compartments for drug particles are covered by the cover plates. FIGS. 6H-6I showed the medicine box 600 with the upper cover plate 601 being at the open position and the lower cover plate 602 being at the closed position, respectively. In this state, compartments are formed (which are defined by the lower cover plate 602 and the cavities 6031) and the compartments are exposed at the upper side for receiving drug particles. As such, dispensed drug particles can be dropped and received in respective compartments in the medicine box 600. FIGS. 6J-6K showed the medicine box 600 with the upper cover plate is at the closed position and the lower cover plate 602 is at the open position. In this status, any drug particles present in the compartments are dropped from the compartments as the compartments are exposed at the lower side. As such, drug particles can be released from respective compartments in the medicine box 600.

FIGS. 6C-6D and 6H-6K showed the driving mechanisms for actuating the cover plates on one side of the medicine box 600. There are two sets of driving mechanisms, which are connected to the two cover plates, respectively. In other words, the upper cover plate 601 and lower cover plate 602 are driven by the upper driving mechanism 610 and the lower driving mechanism 620, respectively. In this example, an upper driving mechanism 610 generally contains an upper driving slider 611 and an upper slider 612, having rolling bearings fastened to the upper cover plate 601 by screws, and a return spring 613. The upper driving slider 611 contains an upper protruding handle 6110 that serves as an upper driving handle, as shown in FIGS. 6C-6D. When the upper driving slider 611 is moved under the actuation of a driving load by the handle 6110, the upper driving slider 612 drives the upper cover plate 610 to move, which will also actuate the upper slider 611 to move. As such, the upper cover plate 601 is moved to an open position. Vice versa. In some examples, the driving load is controlled by the controller or controlling system to control the open and close of the cover plates of the medicine boxes.

The structure and configuration of the upper driving slider 611 and upper slider 612 are mainly to ensure that the upper cover plate can be opened or closed smoothly. One end of the upper return spring 613 is connected to the upper driving slider 611, and the other end is connected with the middle body 603. The movement of the upper driving slider 611 will drive the return spring 613 to move together. During the process of opening the upper cover plate (i.e., moving the upper cover plate at the open position), as the displacement of the upper driving slider 611 increases, the tension of the return spring 613 also gradually increases.

After the driving load actuation on the upper driving slider 611 is stopped or removed, the return spring 613 will pull the upper driving slider 611 backwards and return to the original state, and the upper driving slider 611 will drive the upper cover plate to move back together until the upper driving slider 611 returns to the original, open position, and the upper cover plate is closed (i.e., moving the upper cover plate at the closed position).

Similarly, the lower driving slider 621 and the lower slider 622, as well as the lower return spring 623, which are connected to the lower cover plate 602, will form the lower driving mechanism 620 of the lower cover plate 602, ensuring smooth opening and closing of the lower cover plate 602. In this example, the lower driving mechanism 620 has similar working mechanism with the upper driving mechanism 610 and so will not be repeated for brevity's sake.

FIGS. 6H and 6I showed the states when the upper cover 601 is opened (i.e., at the open position) and the lower cover is closed (i.e., at the closed position). FIGS. 6J and 6K showed the states when the lower cover 602 is at the open position and the upper cover is at the closed position. When either the upper cover 601 or the lower cover 602 are opened, 4×7 separate compartments (and thus the cavities 6031) in the middle body 603 of the medicine box are exposed. Each compartment is used to hold dispensed drug particles respectively. These compartments can form independent storage spaces with the upper cover plate 601 or lower cover plate 602, and the quantity of each drug particles in each compartment is the amount that the patient needs to take at once (per dose).

The upper cover 601 and the lower cover 602 will not open simultaneously when in normal use. The main functions that a medicine box 600 in a dispensing system are as follows: When the medicine box is transported on the production line, both the upper cover plate 601 and lower cover plate 602 of the medicine box 600 are configured to close (i.e., both are at the closed positions), forming closed compartments to ensure that the compartments and any drug particles inside the compartments are not contaminated, and to ensure that the drug particles in each compartment do not affect or contaminate other compartments. When the medicine box 600 is transported by the transportation mechanism to a dispensing station containing one or more dispensing units where drug particles to be dispensed are present, the upper cover plate 601 is configured to open to receive the dispensed drug particles from the one or more dispensing units of the dispensing station. Servo mechanism moves the medicine box be positioned such that required drug particles in required quantity are dropped into the designated compartments. After the required drug particles are dispensed and received in the designated compartments, the upper cover plate 601 is configured to close the compartments (i.e., both cover plates are closed). The medicine box is transported to the next dispensing station(s) in the production line and repeat the processes until all drug particles in need are dispensed. When the medicine box 600 is further transported to the packaging module, the lower cover 602 opens, and the drug particles inside the compartments of the medicine box 600 fall into the respective receptacles in the packaging module. The packaging module is configured to individually package the drug particles in each receptacle.

### Dispensing Methods

In some aspects, provided are methods of automatedly dispensing drug particles.

### Example 7

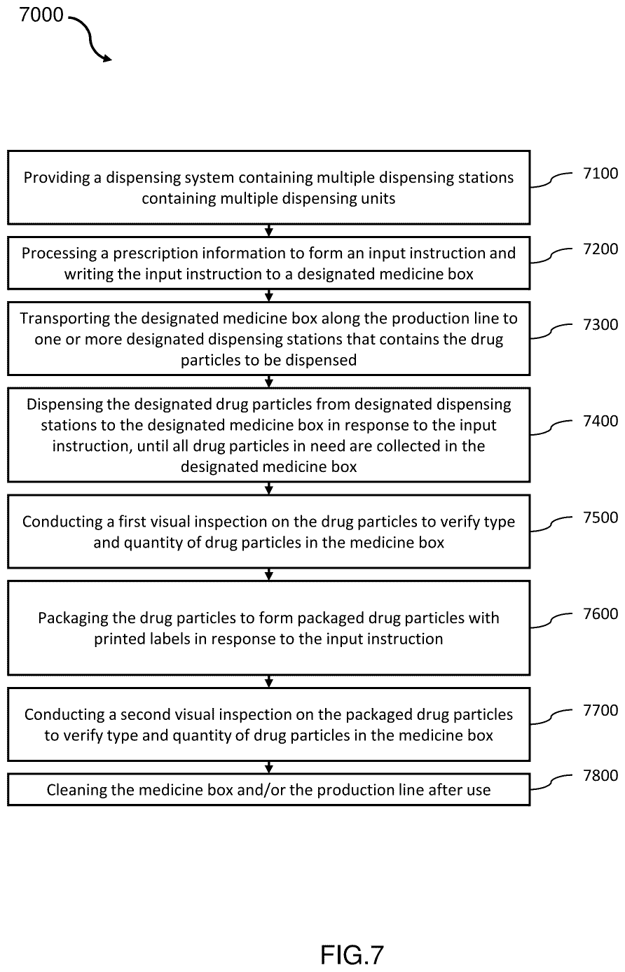

FIG. 7 showed an example flowchart of method 7000 of automatedly dispensing drug particles comprising the steps of:
step 7100: providing a dispensing system as described herein, wherein the dispensing system contains any one or more dispensing stations containing multiple dispensing units as described herein.
step 7200: processing prescription information to form an input instruction and binding the input instruction to a designated medicine box.
step 7300: transporting the designated medicine box along the production line to one or more designated dispensing stations that contains the drug particles to be dispensed; and
step 7400: dispensing the designated drug particles from the one or more designated dispensing stations to the designated medicine box in response to the input instruction, until all drug particles in need are collected in the designated medicine box.

In some examples, the method 7000 optionally further contains the step of:
step 7500: conducting a first visual inspection on the drug particles to verify type and quantity of drug particles in the medicine box based on the input instruction.

In some examples, the method optionally further contains the step of:
step 7600: packaging the drug particles to form one or more packaged drug particles with one or more printed labels in response to the input instruction. In some examples, each package contains the amounts of multiple drug particles in need per dose.

In some examples, the method optionally further contains the step of:
step 7700: conducting a second visual inspection on the packaged drug particles to verify type and quantity of drug particles in the medicine box based on the input instruction.

In some examples, the method optionally further contains the step of:
step 7800: cleaning the medicine box and/or the production line after use.

In some examples, the method further contains the steps of:
determining quantity of each type of drug particles in the system is below a corresponding pre-defined threshold; and
if confirmed, replenishing drug particles in need to a designated dispensing station until the quantity is equals to or above the pre-defined threshold. In some examples, these two steps performed prior to step 7300 or step 7400.

In some methods, wherein the step of replenishing the drug particles to the designated unit of the station comprises the step of:
delivering drug particles by an AGV to the designated dispensing station.

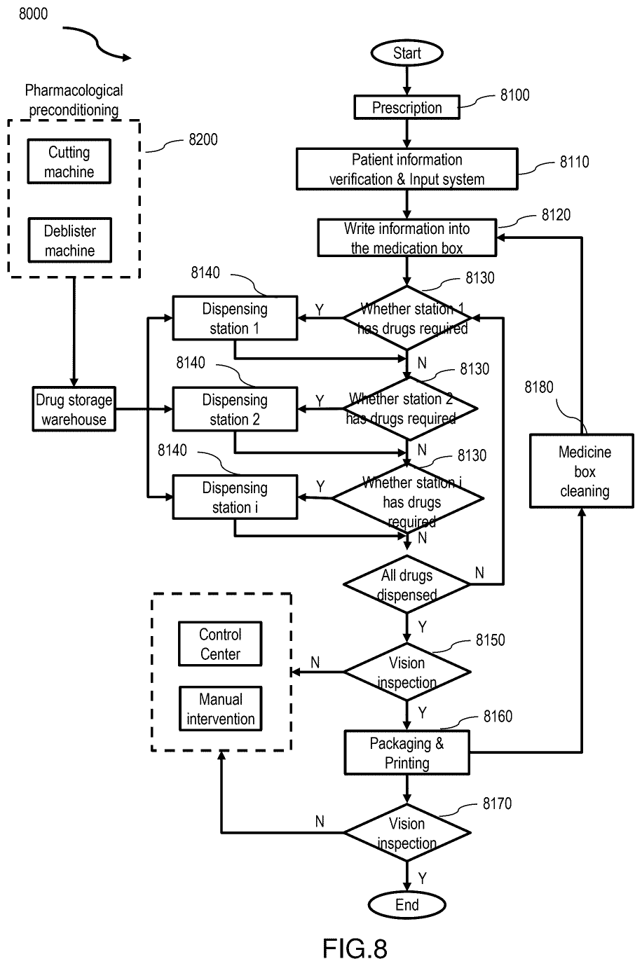

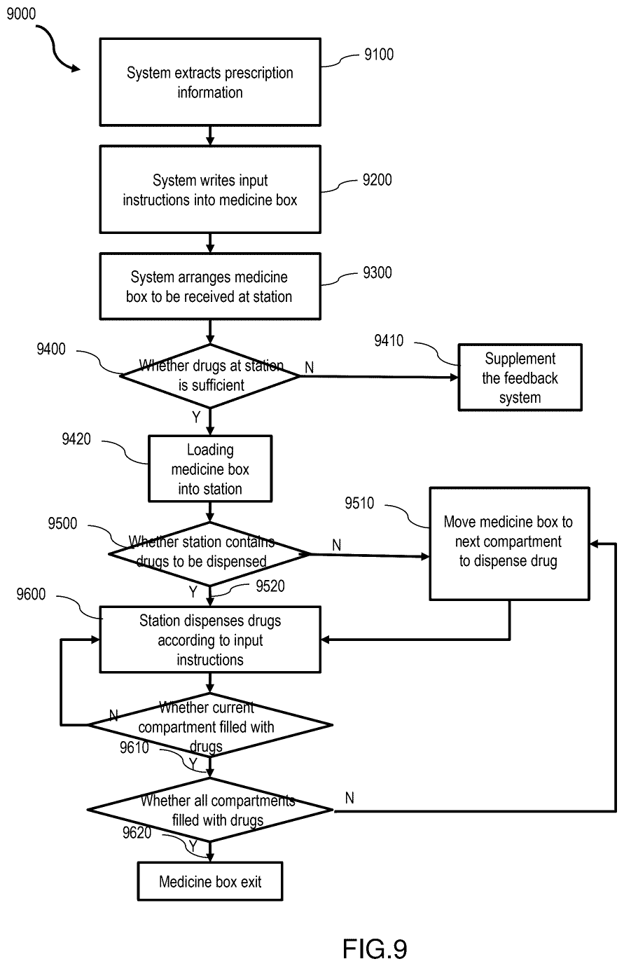

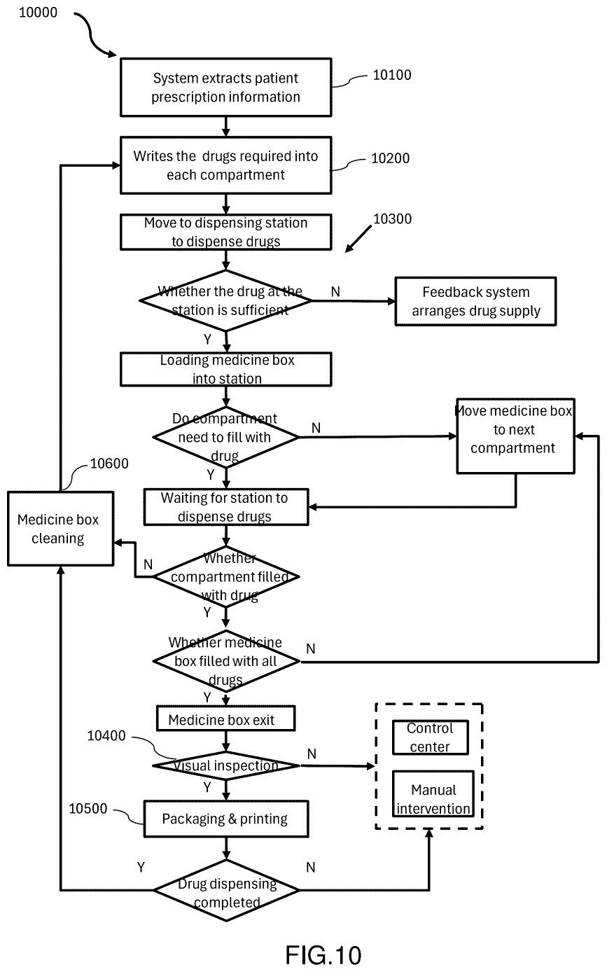

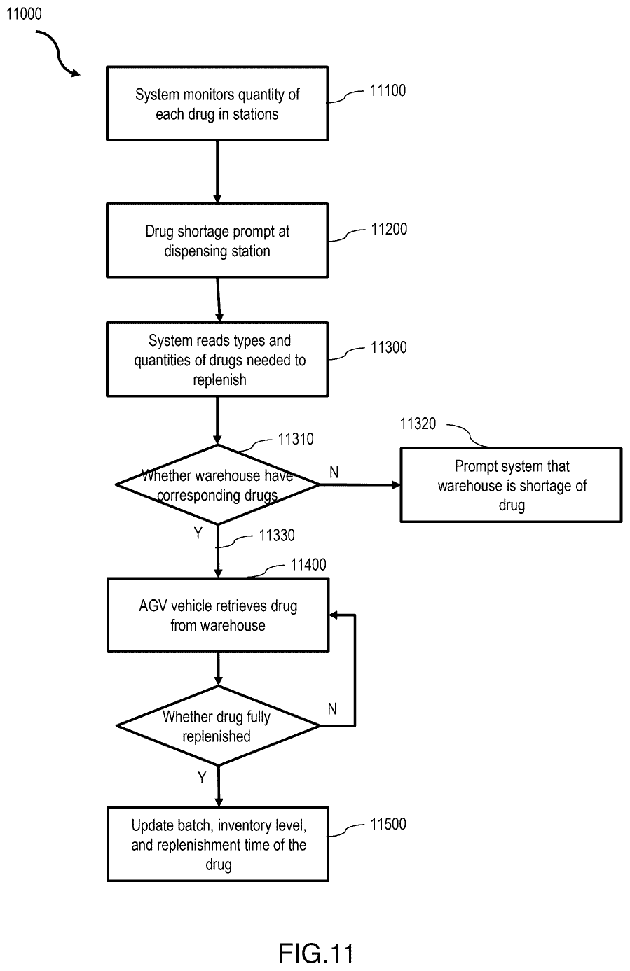

FIGS. 8 to 11 illustrated several other example methods of automated dispensing of drug particles using any one of the example dispensing systems described herein. FIG. 8 showed the flowchart of an example automatic dispensing and packaging system for drug particles. FIG. 9 showed the flowchart of an example automatic dispensing and dispensing process at the dispensing station. FIG. 10 showed the flowchart of an example medicine box movement on the production line. FIG. 11 showed the flowchart of an example automatic replenishment process at the dispensing station.

### Example 8

Now referring to FIG. 8, showing an example automated dispensing method 8000, using an automatic dispensing and packaging system for drug particles. In this example, the example dispensing system containing multiple dispensing stations (1-i), medicine box, transportation mechanism, central control unit with a system database, visual inspection modules, and packaging module is provided.

The workflow 8000 starts from the system receiving the hospital prescription and ends with the final packaging printing. The specific completion process steps are as follows:
Step 8100: receiving and reading a prescription of a patient by the dispensing system. In some examples, the prescription is a hospital prescription issued by doctors. In some examples, the prescription contains or is associated with a patient's information.
Step 8110: verifying the patient information and inputting the same into the system. In some examples, step 8110 includes checking whether the patient information on the prescription is present (i.e., matches with the stored patient information) in the system database. If the patient information is present in the system database, updating the patient information (e.g., adding the latest prescription information in the saved patient information) according to the prescription information. If there is no patient information in the system database, creating a new patient information file and entering the same into the system database.
Step 8120, after confirming the patient information, writing or binding an input instruction such as the information of the drug particles required by the patient (e.g., types and quantity of drug particles to be dispensed) into an empty medicine box through a unique identifier such as a bar code, QR code or RFID tag. The empty medicine box will collect all the drug particles required by the patient by moving on the production line, and the drug particles are dispensed into multiple compartments to separate the dosage. Each compartment contains the amount that the patient needs to take at one time. After the input instruction of the empty medicine box is written, the empty medicine box will move along the production line. During the movement, the medicine box will pass through multiple dispensing stations 1, 2 . . . i.
Step 8130: Each dispensing station or controlling system will confirm or determine whether the station contains the drug particles to be dispensed for the patient is present or not. If there is, the medicine box will enter the dispensing station for dispensing. If not, the medicine box will move to the next dispensing station. The medicine box will go through at least some or all the dispensing stations along the production line until the medicine box contains all drug particles required by the patient are dispensed.
step 8140: checking if all drug particles required are dispensed. If so, the medicine box will then enter the next verification stage. If not, the medicine box will continue entering the production line. Continue the cycle until all drug particles required are dispensed.

In some examples, during the movement of the medicine box on the production line, as the dispensed drug particles inside the medicine box changes, the input instruction (e.g., types and quantity of drug particles to be dispensed) written into the medicine box through the identifier (e.g., bar code or RFID tag) will also be updated according to the changes in the type and amount of drug particles inside the medicine box, until all the drug particles needed by the patient are dispensed in the medicine box, and the input instruction of the medicine box is updated.

In some examples, optionally providing step 8200: conducting pharmacological pre-conditioning. Certain drug particles to be stored in the dispensing stations need to be pre-processed (such as cutting, peeling or removing blister packaging) by a cutting machine or a peeling or deblister machine, and then stored in the drug storage warehouse. The dispensing system will arrange robots or vehicles to automatically replenish the pre-processed drug particles from the drug storage warehouse to the corresponding dispensing station, without the need for manual intervention in the entire process.

Step 8150: conducting a first vision inspection. When the medicine box is filled with the drug particles required in step 8140, it will proceed to the next stage along the production line, where it will be checked and tested. The checking and testing process involves using visual cameras to capture patient information and prescription and processing the visual data, including verifying the types and quantities of dispensed drug particles against the stored visual features of each type of drug particles and the prescription information. In some examples, the visual verification process only needs to verify the drug information in the system information database with the drug information imaged in the medicine box. The verification of drug quantity is confirmed through visual imaging to determine the number or quantify of each type of drug particles. If the verification is correct, the medicine box will enter the next packaging printing stage. If any problems are found during the verification, the system will prompt for manual intervention through the control center to solve the problematic medicine box.

Step 8160: packaging and printing. After the first visual inspection, the medicine box will enter the packaging and printing step 8160 along the production line. When the medicine box reaches the packaging module containing a packaging machine, the packaging machine will cause the medicine box to open and automatically drop the drug particles in into the packaging machine. In some examples, the packaging machine reads the patient information associated with the medicine box and arrange packaging printing based on the patient's information. In some examples, the entire packaging printing process is automated.

Step 8170: conducting a second visual inspection. The packaged drug particles undergo a second visual imaging verification again to determine if there are any errors. If there are errors, the visual inspection module automatically marks the wrong packaging position and prompts the dispensing system to manually intervene through the control center to solve the problem with the packaged drug particles. In some examples, the first and second visual inspection steps are performed in the same visual inspection module. In some examples, the first and second visual inspection steps are performed in separate visual inspection modules.

Step 8180: cleaning medicine box. The used medicine box enters the cleaning process by the cleaning module. The cleaned medicine box will then enter the starting position of the production line to write new patient information and start a new round of dispensing process.

After the entire process of drug dispensing and packaging is completed, and the packaged drug particles will be delivered to the patient in a timely manner. In some examples, the entire dispensing and packaging process can be fully or nearly fully automated, which can reduce manual labor and improve work efficiency. In some examples, independently packaged drug particles can also provide great convenience to patients, especially the elderly.

### Example 9

Now referring to FIG. 9, showing an example automatic dispensing method 9000 using an example dispensing station, including the process of dispensing drugs according to prescription information and placing the dispensed drug particles into the designated location of the medicine box. The specific steps are as follows:
Step 9100: extracting the patient's prescription information by the dispensing system. The patient's prescription information includes the type, quantity, frequency of use, and duration of use of drug particles. The dispensing system processes the patient's prescription information into machine recognizable input instructions.
Step 9200: writing the input instructions into the medicine box. In some examples, the input instructions including the corresponding type and quantity of drug particles in each storage compartment of the medicine box are written into the medicine box through a unique identifier, based on the patient's prescription. Each compartment indicates the type(s) and quantities of drug particles per dose and a corresponding input instructions may be sent to the dispensing station.
Step 9300, arranging medicine boxes to be received at the dispensing station by the dispensing system. Transporting the medicine boxes on the production line to the corresponding dispensing station for drug delivery by the dispensing system.
Step 9400: before the medicine box entering the dispensing station to receive the drug particles, determining, by the dispensing system, whether the quantity of each type of

drug particles required in the dispensing stations is sufficient. If the quantity is not enough, reporting to the control center to arrange for replenishment 9410. If the quantity is sufficient, loading the medicine box into the dispensing station 9420.
Step 9500: before entering into a current dispensing station, determining whether there are any drug particles required to be loaded into the medicine box. If there are no drug particles required to be loaded at the current dispensing station, the medicine box enters the next dispensing station along the production line 9510. If there are drug particles required to be loaded in the next dispensing station, the medicine box will enter the next dispensing station for dispensing 9520.
Step 9600: dispensing drug particles according to input instructions. After the medicine box enters the dispensing station, the dispensing station will dispense the drug particles to each compartment according to the input instructions. In some examples, each dispensing station has 4-12 different types of drug particles, and each dispensing station contains a dispensing outlet. These dispensed drug particles will be dispensed into the corresponding storage compartments of the medicine box through the dispensing outlet 9610. The dispensing system controls each compartment of the medicine box to operatively connect with the dispensing outlet to receive any required drug particles from the dispensing station according to the input instructions. If all the drug particles required in the corresponding compartments are dispensed, the dispensing system will arrange the medicine box to exit the dispensing station 9620. If not, the dispensing system will arrange for the medicine box to continue moving inside the material until all the medicine is received.

### Example 10

An example transportation or movement process 10000 of the medicine box is shown in FIG. 10, which is the entire workflow of the medicine box moving on the production line, and the process steps are as follows:
Step 10100: extracting prescription information into input instructions. The patient's prescription information includes the type, quantity, frequency of use, and duration of use of each drug particle required. The dispensing system processes the patient's prescription information into machine recognizable input instructions.
Step 10200: writing the input instructions into the medicine box. In some examples, the input instructions including the type and quantity of drug particles in each storage compartment of the medicine box are written into the medicine box through a unique identifier, based on the patient's prescription. Each compartment indicates the type and quantity of each drug particle required and a corresponding input instruction may be sent to the dispensing station.
Step 10300: the medicine box entering a dispensing station to complete the dispensing process, and then arrives at the next dispensing station. Before entering the next dispensing station, the dispensing system will determine whether the medicine box needs to enter the next dispensing station based on the input instructions. If there is drug particle that needs to be dispensed at the next dispensing station, the medicine box enters the next dispensing station for dispensing. If there is no drug particles required at the dispensing station, the medicine box will directly move to another dispensing station and make similar determination on whether to enter another dispensing station for dispensing. After the drug particles required and available are dispensed in the medicine box in the particular dispensing station, the system arranges for the medicine box to exit the dispensing station. After leaving the station, the medicine box will enter the next dispensing station to complete the same action until all dispensing stations have filled all the drug particles required by the patient.
Step 10400: visual inspection. The filled medicine box will enter the visual inspection along the production line to check whether the type and quantity of each drug particles required inside the medicine box are correct. If incorrect, the dispensing system will feedback to the control center for manual intervention. If correct, the medicine box will enter the packaging and printing step. In this example, only one visual inspection step is performed prior to packaging and printing step.
Step 10500: packing and printing. The confirmed medicine box will enter the packaging and printing module along the production line. When the medicine box moves to

the packaging machine, the control mechanism of the packaging machine will open the lower cover of the medicine box, allowing all the dispensed drug particles in each compartment to flow into the packaging machine for packaging, respectively. After the dispensing of the medicine box is completed, the empty medicine box will return to the starting position of the medicine box along the production line and start a new round of dispensing.
Step 10600: cleaning medicine box. During the process of moving the empty medicine box back to starting position, there will be a cleaning process on the production line to remove any contamination.

### Example 11

An example automatic replenishment process 11000 of the dispensing station is shown in FIG. 11, which is completed by the dispensing system based on the sufficiency of quantity of each drug particles at the dispensing station. The automatic replenishment process at the dispensing station are as follows:
Step 11100: monitoring quantity of each type of drug particles stored in the dispensing units of the dispensing stations. The dispensing system monitors the quantity of each drug particles stored in the dispensing units in the dispensing stations at all times.
Step 11200: prompting drug shortage at the dispensing station. When the remaining amount of any type of drug particle in the dispensing units of the dispensing station is below a preset threshold value or insufficient, the dispensing station will issue a shortage command to the dispensing system.
Step 11300: reading types and quantities of drug particles required. The dispensing system will read and monitor the type and quantity of drug particles in short supply, and then confirm whether the drug particles required in the warehouse is in stock 11310. If there is no inventory, it will prompt the system warehouse that the drug particles is in short supply 11320. The dispensing system will prepare and order new drug particles for the warehouse based on feedback.
Step 11400: retrieving drug particles from warehouse. If the drug particles stored in warehouse 11330 has stock, the dispensing system will arrange AGV to retrieve them from the warehouse and replenish the same to the corresponding dispensing station that is in short supply of the drug particles.

After the drug particles are replenished, the dispensing station confirms whether the type of drug particles is fully replenished or above a preset threshold value. If it is not full, the dispensing system will arrange for further replenishment. If the dispensing station is full, the dispensing system confirms that the drug particles have been replenished.
Step 11500: updating inventory level and replenishment time. The dispensing system will update the batch number, inventory level, and replenishment time of the drug particles after the completion of this replenishment. At this point, the dispensing station completes the replenishment.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

What is claimed is:

1. An automated dispensing unit for drug particles, comprising
a bowl feeder, comprising
a bowl comprising
a bowl base;
a bowl discharge port; and
a spiral bowl feeder track configured to connect between the bowl base and the bowl discharge port;
a feeder track, comprising
a feeder track inlet; and
a feeder track outlet;
a discharge mechanism, comprising
a driving cylinder; and
a pick; and
a blanking track, comprising
a blanking track inlet; and
a blanking track outlet,
wherein, when in operation, the bowl feeder is configured to vibrate such that the drug particles disposed in the bowl are moved upward towards the bowl discharge port along the spiral bowl feeder track,
wherein the bowl discharge port is configured to operatively connect with the feeder track inlet, and the feeder track outlet is configured to operatively connect with the discharge mechanism, such that the drug particles from the bowl feeder are received and delivered to the discharge mechanism along the feeder track, and
wherein the driving cylinder is configured to drive the pick to be movable between a first position that is juxtapose with the feeder track outlet and a second position that is juxtapose with the blanking track inlet, such that at least one drug particle is dispensed into the blanking track by the pick when the pick is moved from the first position to the second position.

2. The drug dispensing unit of claim 1, further comprises a plurality of sensors directed to the unit to monitor quantity of drug particles at different locations.

3. The drug dispensing unit of claim 2, wherein the plurality of sensors are photoelectric sensors that comprise:
a first photoelectric sensor directed to the bowl base to monitor quantity of the drug particles inside the bowl;
a second photoelectric sensor directed to the feeder track inlet to monitor quantity of the drug particles at the feeder track inlet;
a third photoelectric sensor directed to the feeder track outlet to monitor quantity of the drug particles at the feeder track outlet; and/or
a fourth photoelectric sensor directed to the blanking track outlet to monitor quantity of the drug particles at the blanking track outlet.

4. The drug dispensing unit of claim 1, wherein the feeder track is configured to vibrate to move the drug particles along the feeder track.

5. The drug dispensing unit of claim 1, further comprises a storage bin for storing a plurality of drug particles, wherein the storage bin is configured to open to deliver drug particles stored in the storage bin to the bowl feeder in response to a pre-defined quantity of the drug particles inside the bowl monitored by the first photoelectric sensor.

6. The drug dispensing unit of claim 1, wherein the bowl feeder is configured to vibrate in response to a pre-defined quantity of the drug particles monitored by the second photoelectric sensor.

7. The drug dispensing unit of claim 1, wherein the feeder track is configured to vibrate in response to a pre-defined quantity of the drug particles monitored by the third photoelectric sensor.

8. The drug dispensing unit of claim 1, further comprises a shell to enclose the bowl feeder, the feeder track and the discharge mechanism, wherein the shell comprises one or more of the following features: sound-proof, moisture-proof, dust-proof, light shielding and combination thereof.

9. The drug dispensing unit of claim 1, further comprises or operatively connects with a negative pressure air circulation filtration device to clean any dust pollution in the dispensing unit.

10. The unit of claim 1, wherein the feeder track has an adjustable plate for adjusting the width of the track.

11. An automated dispensing station for drug particles, comprising one or more drug dispensing units as claimed in claim 1.

12. The drug dispensing station of claim 9, further comprising a frame comprising a drug collection layer at bottom, and one or more dispensing layers positioned above the drug collection layer, each dispensing layer is configured to house one or more drug dispensing devices.

13. The drug dispensing station of claim 10, wherein individual dispensing layer comprises a dispensing pipe configured to deliver the drug particles dispensed from the one or more drug dispensing units to the drug collection layer.

14. The drug dispensing station of claim 9, further comprising a station controller that is operatively connected with the one or more dispensing units and the plurality of photoelectric sensors.

15. The drug dispensing station of claim 9, further comprises a servo mechanism configured to control relative position of a medicine box that comprises a plurality of compartments at the drug collection layer to receive the drug particles dispensed from the one or more drug dispensing units to a designated compartment of the medicine box.

16. A system for automated dispensing of drug particles, comprising
a plurality of dispensing stations as claimed in claim 11;
a plurality of medicine boxes, configured to receive drug particles dispensed from at least one dispensing station;
a transportation mechanism, operatively connected with the plurality of dispensing stations and configured to transport one or more of the medicine boxes to at least one of the plurality of dispensing stations to form a production line; and
a central control unit, configured to control operation of the system, wherein one or more designated medicine boxes are transported along the production line, and one or more designated drug particles are dispensed from one or more designated dispensing stations and collected in the one or more designated medicine boxes, in response to one or more input instructions.

17. The system of claim 16, further comprising
a visual inspection module configured to receive a medicine box and verify type and quantity of the drug particles in the medicine box.

18. The system of claim 16, further comprising a packaging module configured to package dispensed drug particles as packaged drugs, and print at least one label thereon.

19. The system of claim 18, wherein the packaging module comprises a packaging material supply device, an information printing device, and an automated packaging device.

20. The system of claim 16, further comprising a cleaning module configured to clean the medicine boxes and the production line.

21. The system of claim 20, wherein the cleaning module comprises a cleaning nozzle, a cleaning agent supply system, and a vacuum device, wherein the cleaning nozzle is configured to connect with the cleaning agent supply system to apply a cleaning agent from the cleaning agent supply system to the production line and/or medicine boxes after use for cleaning, and wherein the vacuum device is configured to remove any residues and dust after cleaning.

22. The system of claim 21, wherein the medicine box comprises a plurality of compartments, wherein each of the dispensing station further comprises a servo mechanism configured to control relative position of the medicine box in the drug collection layer to receive the drug particles dispensed from the one or more drug dispensing units to a designated compartment of the medicine box.

23. The system of claim 22, wherein the medicine box further comprises two cover plates and a medicine box body sandwiched therebetween to form the plurality of compartments, wherein the medicine box body defines a plurality of cavities, the cover plates are respectively configured to be switchable between at least an open position and a closed position relative to medicine box body, wherein at the open position, one or more compartments are exposed, and at the closed position, one or more compartments are covered.

24. A method of automatedly dispensing drug particles, comprising the steps of:
providing a system as claimed in claim 17;
processing a prescription information to form an input instruction, and binding the input instruction to a designated medicine box;
transporting the designated medicine box along the production line to one or more designated dispensing stations; and
dispensing the designated drug particles from the one or more designated dispensing stations to the designated medicine box in response to the input instruction, until all drug particles in need are collected in the designated medicine box.

25. The method of claim 24, further comprising the step of:
conducting a first visual inspection on the drug particles to verify type and quantity of drug particles in the medicine box based on the input instruction.

26. The method of claim 24, further comprising the step of:
packaging drug particles to form one or more packaged drug particles with one or more printed labels in response to the input instruction.

27. The method of claim 24, further comprising the step of:
conducting a second visual inspection on the packaged drug particles to verify type and quantity of drug particles in the medicine box based on the input instruction.

28. The method of claim 24, further comprising the step of:
cleaning the medicine box and/or the production line after use.

29. The method of claim 24, further comprising the step of:
determining quantity of each type of drug particles in the system is below a corresponding pre-defined threshold;
if confirmed, replenishing drug particles in need to a designated dispensing station until the quantity is equals to or above the pre-defined threshold.

30. The method of claim 29, wherein the step of replenishing the drug particles to the designated unit of the station comprises the step of: delivering drug particles by an AGV to the designated dispensing station.
